(19) United States
(12) Patent Application Publication
(10) Pub. No.: US 2004/0268229 A1
(43) Pub. Date: Dec. 30, 2004

(54) Markup language editing with an electronic form

(75) Inventors: Jean D. Paoli, Kirkland, WA (US); Adriana Ardeleanu, Redmond, WA (US); Christian Stark, Kirkland, WA (US); Jonathan E. Rivers-Moore, Bellevue, WA (US); Evgeny N. Veselov, Sammamish, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/609,238

(22) Filed: Jun. 27, 2003

(51) Int. Cl. G06F 17/21

(52) U.S. Cl. 715/508; 715/505; 715/507

(57) ABSTRACT

A display is made of an electronic form that contains operable fields corresponding to components that correspond to nodes in a tree arrangement of hierarchical data. Each node has a structure. The operable fields have a hierarchical arrangement in the display of the electronic form. The hierarchical arrangement of the operable fields in the electronic form visually mimics the nodes in the tree arrangement of hierarchical data and also mimics the structure of each node. A user can enter data into the operable fields of the electronic form and the data is received. Each node has an attribute that defines the availability of actions to the user when the user enters the data into the operable fields of the electronic form. The hierarchical data in a data file is altered to correspondingly reflect the data that has been entered by the user.

### TECHNICAL FIELD

This invention generally relates to writing data to, and viewing data in, an electronic form that is related to a markup language file, and more particularly, to context sensitive, feature rich editing of the markup language file using an electronic form.

### BACKGROUND

Extensible markup language (XML) is increasingly becoming the preferred format for transferring data. XML is a tag-based hierarchical language that is extremely rich in terms of the data that it can be used to represent. For example, XML can be used to represent data spanning the spectrum from semi-structured data (such as one would find in a word processing document) to generally structured data (such as that which is contained in a table). XML is well-suited for many types of communication including business-to-business and client-to-server communication. For more information on XML, XSLT, and XSD (schemas), the reader is referred to the following documents which are the work of, and available from the W3C (World Wide Web consortium): XML Schema Part 2: Datatypes; XML Schema Part 1: Structures, and XSL Transformations (XSLT) Version 1.0; and XML 1.0 second edition specification.

One of the reasons that data files written in XML are often preferred for transferring data is that XML data files contain data, rather than a combination of data and the software application needed to edit the data. To edit an XML data file, a user typically must interactively install a solution software application used to access, view, and edit the data file. When the user is online, the user's computer can run a host application capable of accessing the Internet, such as Microsoft® Internet Explorer®, which can silently discover and deploy a solution, which can be written in XSLT, where the solution enables the user to author and access an XML data file.

The authoring of and access to XML data files is frequently performed in conjunction with the collection of information electronically using electronic forms. The collection of information in electronic forms is for the purpose of transferring data—for both business to business and client to server types of communications. These electronic forms can be used, mainly through human interaction, for the creation of markup language data, as well as the modification of existing markup language data. While the users that enter data with electronic forms are typically also familiar with word processor applications, word processor application are not used in conjunction with these electronic forms. Rather, tools for using the electronic forms must be custom built applications or must use proprietary electronic forms tools. Data entry using such electronic forms tools lacks many convenient features provided by modern data word processing applications, such as the Microsoft Word® word processing application of the Microsoft Corporation of Redmond, Wash.

Given the foregoing, it would be an advantage in the art to allow a user to do data entry into an electronic form for the creation and modification of markup language data, where the user's data entry experience would be similar to a word processing experience, and where the user's view of the markup language data in the electronic form would be an HTML representation of the markup language data.

### SUMMARY

The following description and figures describe methods, systems, apparatus, computer-readable medium, and user interfaces for receiving input to open a markup language data file for which there is a solution. The solution, which can be silently discovered and deployed without user interaction, is useful in junction with an interactive tool that enables a user to enter, edit, and view data with respect to the markup language data file through an electronic form having one or more operable fields. Once the solution is deployed, the markup language data file is opened with the solution, the electronic form is displayed, data in the markup language data file is seen in the one or more operable fields, and the user is enabled to edit the data in the one or more operable fields of the electronic form. The user's editing of the data correspondingly changes the data in the markup language file. The data that is entered into the markup language file with the electronic form can be repurposed.

The solution defines the availability to the user of one or more actions when the user is entering or editing data for each operable field of the electronic form. The actions that become available to the user are context sensitive. By way of example, such a context occurs where an input device that the user is using becomes associated with one of the operable fields, such as by clicking on or performing an action that selects the operable field. When such a context arises, certain actions defined in the solution with respect to the operable field become available to the user. These actions can be specified in the solution so as to provide the user with a word processor-like data entry experience when using the electronic form.

The markup language data file to which the solution corresponds has a structure that includes a hierarchical arrangement of a plurality of nodes, where each node has a structure. One or more operable fields in the electronic form are mapped to corresponding nodes of the markup language data file. A presentation application in the solution, when executed in conjunction with the opening of the markup language data file, displays data in the markup language data file in the one or more of the operable fields in the electronic form. As such, the user sees an HTML representation of the data in the markup language data file in a view of the electronic form and its corresponding operable fields. The solution, which can be modified, declaratively defines aspects of the markup language data file such as its elements, attributes, and values, as well as the actions that are made available to the user based upon a context with respect to the one or more operable fields of the electronic form.

### BRIEF DESCRIPTION OF THE DRAWINGS

The detailed description is described with reference to the accompanying figures in which the same numbers are used throughout the disclosure and figures to reference like components and features. Series 100 numbers refer to features originally found in FIG. 1, series 200 numbers refer to features originally found in FIG. 2, and series 300 numbers refer to features originally found in FIG. 3, and so on.

FIG. 1 illustrates an exemplary screen having a display area depicting a rendered travel itinerary electronic form and an incomplete view of a rendered form of a hierarchical data file, where both the travel itinerary electronic form and the rendered form of the hierarchical data file correspond to the hierarchical data file, and where the travel itinerary electronic form can be used by a user to enter travel data into the hierarchical data file, to edit data in the hierarchical data file, and to view data in the hierarchical data file.

FIG. 2 illustrates an exemplary screen display depicting the travel itinerary electronic form seen in of FIG. 1, where data has been entered into a plurality of data-entry fields of the travel itinerary electronic form.

FIG. 3 is a flow diagram of an exemplary process for real-time, context sensitive data entry and data validation.

FIG. 4 illustrates an exemplary screen display showing the travel itinerary electronic form of FIG. 2 with a data-entry field having an invalid entry that is reflected in a dialog box.

FIG. 5a illustrates an exemplary screen display depicting the travel itinerary electronic form seen in of FIG. 1, where a user has input a command to pull down a menu in order to request the insertion of a repeating appointment section below a completed appointment section that is to be used to input information with respect to another appointment.

FIG. 5b illustrates an exemplary screen display depicting a different view of the travel itinerary electronic form seen in FIG. 1, where a user has input a rich text field into the travel itinerary electronic form.

FIG. 6a illustrates an exemplary screen having a display area depicting a rendered purchase request having an address block in which an insertion point is displayed.

FIG. 6b illustrates the exemplary screen seen in FIG. 6a, where a user inputs a selection of the address block and successive menu commands to requesting a change of the address block.

FIG. 7a illustrates the exemplary screen seen in FIG. 6a, where a user inputs a request, via a right click mouse action and successive menus commands, to requesting a change of the address block.

FIG. 7b illustrates the exemplary screen seen in FIG. 7a, where the user's input results in a replacement of the address block.

FIG. 8 illustrates a communications network and a system capable of implementing a method for silently discovering and deploying a solution that corresponds to a data file having a hierarchical arrangement of a plurality of nodes, where the method includes use of the solution with an interactive tool that enables a user to enter, edit and view richly formatted data in the data file, which data can be bound to a schema for reuse after the data is stored in the data file.

FIG. 9 illustrates a block diagram have components for an XML solution corresponding to an XML document.

FIG. 10 is a block diagram that illustrates an exemplary collection of files that make up an electronic form template, where an application to use the electronic form template is invoked when a user navigates to an XML document.

FIG. 11 is a flow diagram illustrating exemplary relationships between design components for an electronic forms application, runtime components for using an electronic form designed using the design components, and solutions components that are preexisting electronic forms that can be used with the electronic forms application.

FIG. 12a is a flow diagram illustrating an exemplary process to deploy a form template in which a user opens a form of a certain type to automatically download the corresponding latest version of a form template that is stored on the user's machine so that the user can use the form template when not connected to a network.

FIG. 12b is a flow diagram illustrating an exemplary process to deploy a form template by installation directly on a user's computing device, where the form template can be packaged as an executable module.

FIG. 13 is a flow diagram of an exemplary process for discovering a solution for a data file and for editing the data file while online or offline.

FIG. 14 illustrates an example of a computing environment within which the solutions, software applications, methods and systems described herein can be either fully or partially implemented.

### DETAILED DESCRIPTION

The following disclosure describes ways for a user to use an electronic form in order to enter, edit and view richly formatted data in a data file, where the user is provided with a feature-rich data entry experience similar to word processing. Also described is a way to access the data file, either when online or when offline. If a user has opened the data file first online, or if the system has otherwise received the data file's solution, an electronic forms application can silently discover and deploy the data file's solution. The data file's solution declaratively defines aspects of the data file such as its elements, attributes, and values, as will be discussed below. The electronic forms application allows a user to simply select a data file to open and the electronic forms application will open the data file with a discovered and deployed solution. The user need not discover, select, or even be aware that the data file requires a solution for the data file to be edited. After selecting the data file to open, the user can then edit and access the data file in a way very similar to how it would act and appear had the user opened the data file while online.

Data Files, Solutions, and Host Applications

Data files, their solutions, and a host application work together to allow a user to open and edit the data files. Data files contain little or no operable code, where as a solution file contains presentation and logic applications. The presentation and logic applications of a solution file declaratively define aspects a data file such as its elements, attributes, and values. The elements, attributes, and values that are declaratively defined can include a schema for the data file, one or more views that can be used for viewing and entering data in the data file, a manifest of one of more files that enable contextual editing of the data file, and one of more user interfaces that can be used with the one or more views. Functional components such as toolbars, menu bars, buttons, or task pane for the one or more views are also declaratively defined. Other declaratively defined elements, attributes, and values include a usage of specific event handlers and/or specific error handlers, and a definition of one or more back-end servers to which connectivity is available.

The elements, attributes, and values can also be programmatically defined in addition to the foregoing declarative definition. Specifically, the programmatic definition can be written in a programming code using a scripting language and can include validation rules for data entry with respect to the data file, custom error processing, implementations of data routing (data submission), and algorithms for connecting programmatically to databases, Web services or other back-end systems.

Editing a data file can be done by use of a solution. If a user tries to open a data file without a solution, the user could get an error, a prompt asking the user to open a solution, or perhaps a flat list of the data in the data file. In order to view and edit the data file, it is preferable that a solution for the data file is used. As such, a solution has a corresponding solution application for the data file. The solution application is one or more files that, when installed, are used to enable a user to view, access, and edit the data file.

In addition to the data file and its solution, a host application is needed. This application works to enable the solution to function fully. In this description, an electronic forms application is described, which is capable not only of acting as a host application (allowing a solution to function properly), but can also allow a user to open a data file without actively finding and installing the data file's solution.

For discussion purposes, the implementation described herein are described in the context of a single computer, a communications network, a user-input device, and a display screen. These devices will be described first, followed by a discussion of the techniques in which these and other devices can be used.

Examples of Electronic Forms and Richly Formatted Data Entry

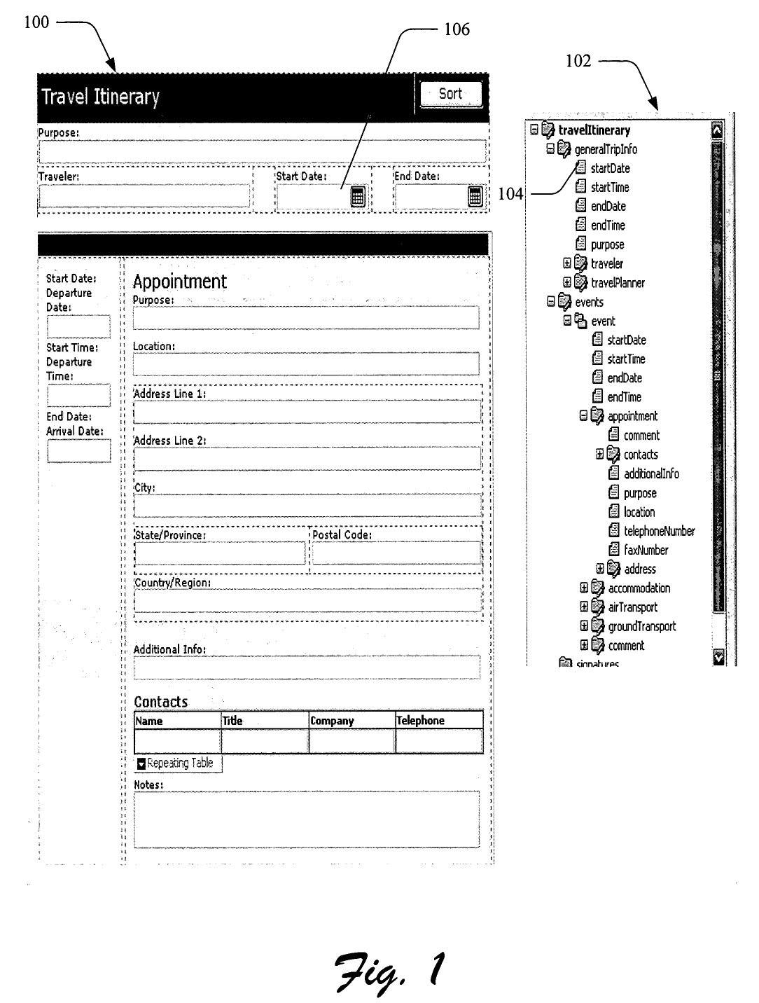

FIG. 1 shows an electronic form 100 entitled “Travel Itinerary”, which is generated by a solution. This travel itinerary form 100 contains data-entry fields in which a user can enter data. These data-entry fields map to a data file so that the data entered into the form are retained in the data file. FIG. 1 shows a graphical representation of the data file as a data file tree 102. The data file tree 102 shows icons representing nodes of the data file. Many of these nodes correlate to data-entry fields shown in the travel itinerary rendered form 100. For instance, a trip start date node 104 correlates to the trip start date data-entry field 106. Thus, data entered by a user into the trip start date data-entry field 106 can be stored in the trip start date node 104 of the data file.

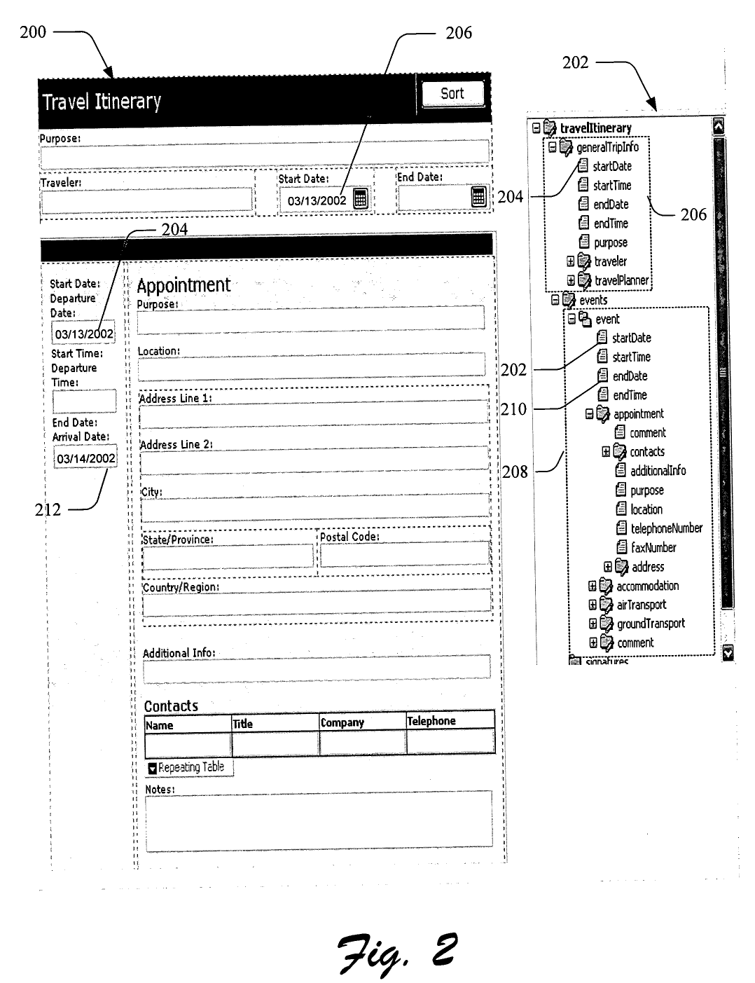

FIG. 2 shows a travel itinerary form 200 that has been rendered similar to travel itinerary form 100 seen in FIG. 1, where some of the data-entry fields have been filled in. Here, the rendered form is generated after data was input by a user into the trip start date data-entry field 206 as “Mar. 13, 2002”. For instance, an electronic forms application can produce a rendering file that is rendered to output the travel itinerary form 200 to a display. In this example, a trip start date data-entry field 204 corresponds to an event start date node 202, and a trip end date data-entry field 212 corresponds to an event end date node 210.

Real-Time, Feature Rich, Context Sensitive Data Entry with Validation

Overview

A system can display an electronic form with data-entry fields to allow a user to enter data. The user can enter feature-rich data in a data-entry field and know, as the data is being entered, whether or not the data is valid or invalid. By so doing, the system provides an easy, intuitive, and efficient way for a user to enter and correct feature-rich data intended for a structured data file.

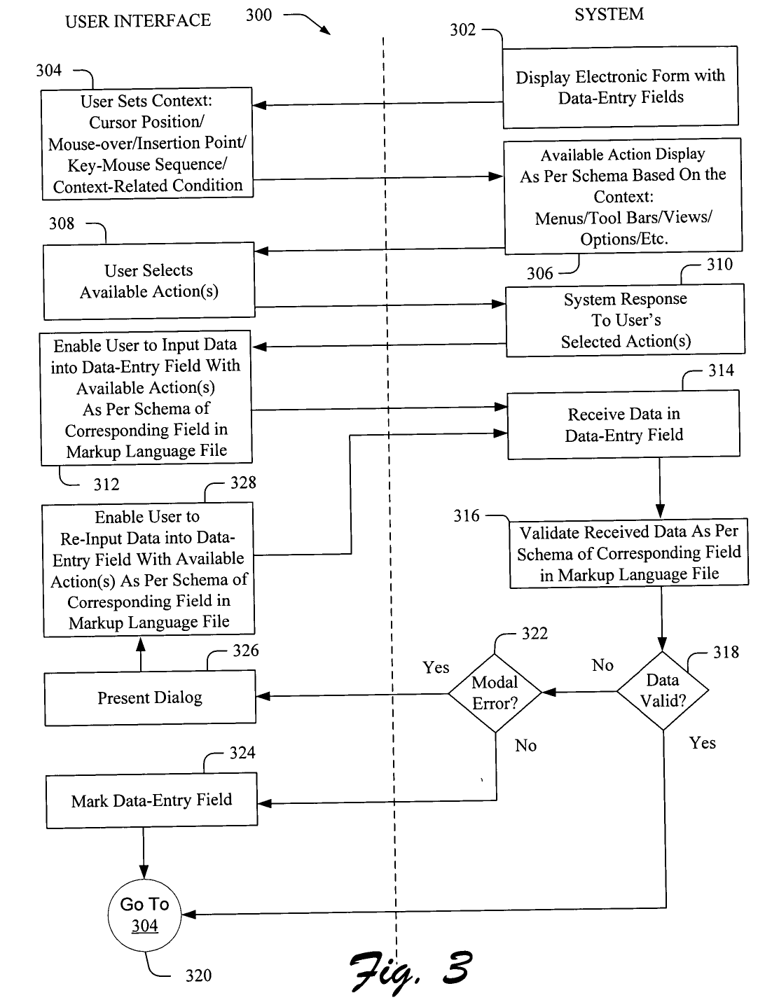

FIG. 3 shows a process 300 for entering data into an electronic form in real-time. The process 300 is illustrated as a series of blocks representing individual operations or acts performed, for instance, by the system 802. The process 300 may be implemented in any suitable hardware, software, firmware, or combination thereof. In the case of software and firmware, the process 300 represents a set of operations implemented as computer-executable instructions stored in memory and executable by one or more processors.

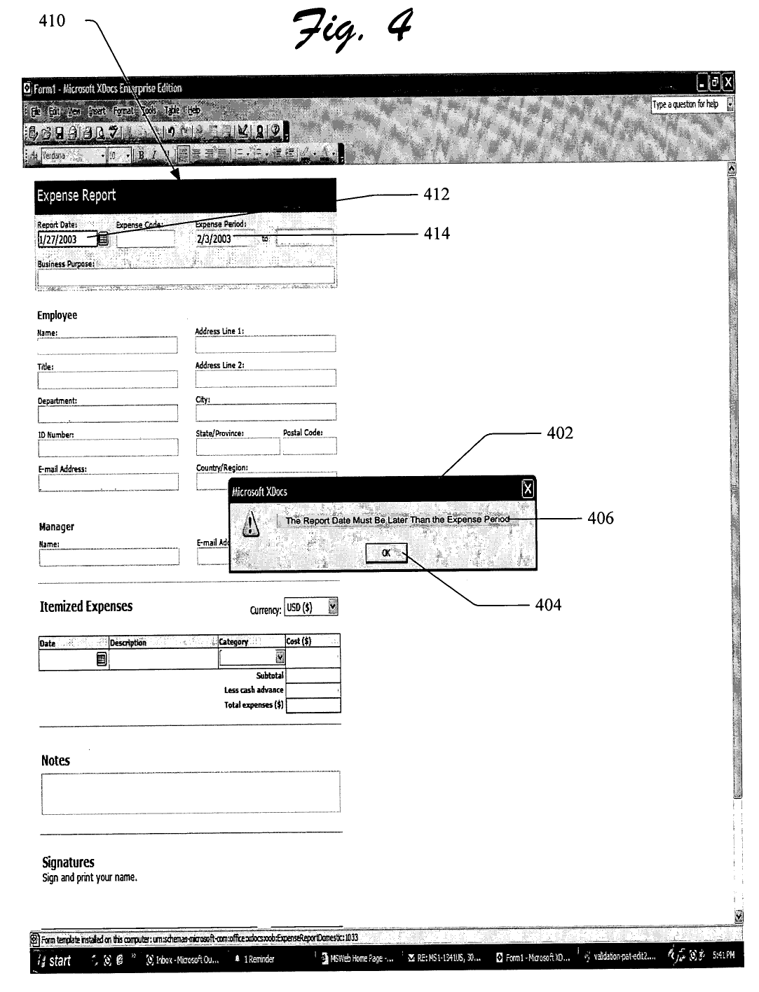

At block 302, the system displays an electronic form having data-entry fields. The electronic form can contain blank or filled data-entry fields. An expense report electronic form 410 in FIG. 4 is an example of an electronic form that contains data in data-entry fields.

The system that displays the expense report electronic form 410 makes a user comfortable with editing the electronic form. This is done by presenting the electronic form with user-friendly, rich features like those used in popular word-processing programs, such as Microsoft® Word®. These user-friendly, rich features include spell checking, auto-complete, and autocorrect. The rich features are discussed below with respect to actions that are available to a user for selection during data-entry using an electronic form. Certain features, like undoing previous entries on command, advancing from one data-entry field to another by clicking on the data-entry field or tabbing from the prior data-entry field, cut-and-paste abilities, and similar features are included to enhance a user's data-entry experience.

After block 302, process 300 moves to block 304 where a user can set a context by use of an input device, such as a keyboard and/or a mouse. The particular context can be dependent upon one or more events. The availability of actions to the user concurs with an event. This event can be an association of an input device being used by the user with one of the data-entry fields on the electronic form. The event can also be the location of the cursor position such that it is proximal to one of the data-entry fields. Another event can be the selection of one of the data-entry fields by the user using one or more input devices. Still another event can be the activation, such as a special operation, performed upon one of the data-entry fields on the electronic form by the user's use of one or more input devices. An event may also occur when certain conditions are met or not met with respect to data in the one of the data-entry fields. An event can also occur when the user's mouse pointer rests over, within, or proximal to an editable region of one of the data-entry fields (e.g., a mouse-over). Still another event can occur when the user's mouse pointer rests over, within, or proximal to an editable region of one of the data-entry fields and the mouse is clicked one or more times. Other user-induced events, such as combinations of keyboard and mouse functions which may or may not be connected with one or more data-entry fields on the electronic form, are also contemplated.

After the user has set the context using one or more input devices at block 304, process 300 moves to block 306 where the availability of one or more actions to the user for entering data into the data-entry fields is displayed. The data file into which data is entered by the electronic form has a solution that defines the actions that are available to the user based upon the context set by the user with the one or more input devices at block 304. As stated above, the availability of actions to the user concurs with one or more of the foregoing events and is based upon a schema, given the context set by the user's input device. The result of the coincidence of the event and the context is a display of the available actions.

The user who sees the display of the available actions can make a selection, at block 308, from among the available actions. Each action that can be selected depends, as stated above, upon the event that occurs and the context set by the user's one or more input devices. The actions that are available can be declaratively specified in the solution corresponding to the data file into which data input into the electronic form will be stored.

The selectable action can be a request for a display of a menu or an activation of a menu item of a menu. The action that might be selected can be a request for a display of a tool bar or an activation of a command tool of a tool bar. The selected action might also be a feature rich editing operation with respect to data in one of the data-entry fields, where the editing operation can be an undo function, a redo function, a copy function, a cut function, a paste function, an insertion of a hyperlink, a carriage return, or line feed function. The action that the user selects at block 308 can also be the performance of a character formatting operation with respect to data in one of the data-entry fields. Such a character formatting operation can be characterized as boldface, italics, underlining, a change of font size or font color, character spacing, or text effects. The action selected can also be adding, entering, updating or deleting, with respect to one of the data-entry fields, a repeating operable field, an optional operable field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, or a time. In can be noted that the availability of each action might be determined on the basis of the context set by the user for one of the data-entry fields and also with respect at least one data-entry field on the electronic form. For instance, the selectability of an action may depend upon the data value in two (2) different data-entry fields of the electronic form.

Once the user has selected one or more of the displayed available actions at block 308, process 300 moves to block 310 where the system responds to the user's one or more selected actions. The response of the system is an enabling of a user interface, at block 312, to input data into one of the data-entry fields with the selected available action. The selected action, as discussed above, is declaratively defined in schema for a field in a markup language file (e.g., an XML file) that corresponds to the data-entry field being used by the user for data input. Thus, at block 312, the electronic form is presented to the user, and the system enables the user to input data into a data-entry field. The user can type in data, cut-and-paste it from another source, and otherwise enter data into the fields. The user can use user-input devices for the data entry, including a keyboard and other device(s) such as a touch screen, track ball, voice-activation, and the like. In FIG. 4, for example, the user enters “Jan. 27, 2002” into the report date data-entry field 412 of the expense report 410.

At block 314, the system receives the data that was input into the data-entry field. For example, the data entered into the data-entry field 412 by the user is received from the user through the user's use of one or more input devices and the user interface. The system can receive the data character-by-character, when the data-entry field is full, or when the user attempts to continue, such as by tabbing to move to another data-entry field. In the foregoing example, the system receives “Jan. 27, 2002” from the user when the user attempts to advance to the next data-entry field.

At block 316, the data received in the data-entry field is validated. The validation determines whether the data input into the data-entry field was valid given the schema for a field in a markup language file (e.g., an XML file) that corresponds to the data-entry field into which the user made the input. This schema can be one or more validation rules. The system validates the data received into the data-entry field in the electronic form by using the validation rules. These validation rules are stored in the solution for the field in the markup language file (e.g., an XML file) that corresponds to the data-entry field into which the user made the input. The system can analyze the data to determine if it is valid. The validation rules govern the particular data-entry field (in this example the report date data-entry field 412). The data entered into a data-entry field is validated without the user having to save or submit the electronic form. It can do so by applying validation rules associated with a node of a structured data file corresponding to data-entry field into which the data was entered.

The validation rules can be derived from various sources. One source for validation rules is a schema governing the field in the markup language file (e.g., the XML file) that corresponds to the data-entry field into which the user made an input of data. Other sources of validation rules can include preset and script-based custom validation rules.

For script-based custom validation rules, the validation rules refer to multiple nodes in the markup language file (e.g., the XML file), including nodes governing or governed by other nodes. Thus, the data from a data-entry field intended for a particular node can be validated by checking validation rules associated with that particular node. In so doing, the data can be validated with respect to one node of a group with the validation rules governing the group of which the node is a part. For example, if a group of nodes contains four nodes, and is associated with a script-based validation rule requiring that the total for the data in all of the four nodes not exceed 1000, the validation can validate each node against this rule. Thus, if the first node contains 100, the second 400, and the third 300, the validation will find the data intended for the fourth node invalid if it is greater than 200 (because 100+400+300+200=1000).

In some cases the validation can build validation rules from a schema containing logic that governs the markup language file. This logic sets forth the bounds of what data the nodes in the markup language file can contain, or the structure that the nodes should have. Data entered into the markup language file can violate this logic, making the markup language file invalid. This invalid data may cause a structural error or a data-type error in the markup language file, possibly making the markup language file useless. To combat this, the validation can build validation rules from a markup language file's schema.

Because structural errors are especially important, the validation treats these types of errors seriously. To make sure that a user treats these errors seriously, the real-time validation builds validation rules for structural errors that stop a user from continuing to edit an electronic form if the validation detects a structural error. Validation rules that stop the user from continuing to edit the electronic form (except for fixing that invalid data) are called modal validation rules, and errors that violate them, modal errors.

For less serious errors, such as data-type errors, the validation builds validation rules that do not stop the user from continuing. These are called modeless validation rules, and errors that violate them, modeless errors.

To aid the validation in validating data in real-time, validation rules are associated with particular nodes. By so doing, with each new piece of data received, the validation is capable of comparing the data received against an appropriate list of validation rules associated with the node for which the data received is intended. Because this list of validation rules can be very short for each particular node, the validation has fewer validation rules to check for each piece of data entered than if it had to check all the validation rules for the node's structured data file. This speeds up the process of validation.

Continuing the previous example, at the block 316 the system validates the data entered, “Jan. 27, 2002”, against validation rules associated with the report date data-entry field 412, thereby determining if the data entered is valid.

In block 318 the system determines whether to proceed to block 304 or block 322, depending on whether the data is valid. If the validation determines that the data entered is not valid, the process 300 proceeds to the block 322, discussed below. If, on the other hand, the validation determines the input in the data-entry field to be valid, process 300 moves to block 320 for a transition back to block 302 such that the user can continue data-entry and editing using the next data-entry field in the electronic form, depending on the user's preference. Continuing the ongoing example, if the validation determines that the data “Jan. 27, 2002” is valid, the process 300 continues on to the block 302. If not, it proceeds to block 322.

At the block 322, the data is invalid and the process 300 performs a still further determination as to whether the invalidity of the data is a modal error. If so, then process 300 moves to block 326 where a diagnostic representing the modal error is presented to the user. The diagnostic, for example, can present a dialog box or other presentation manner explaining the error or what type of data is required by the data-entry field. The validation can present a short comment that disappears quickly or is only shown if the user moves his cursor or mouse pointer over the data-entry field. The validation can also provide additional information on request. Many manners of showing the user that the data is invalid as well as showing information about the error can be used. These ways of notifying the user can be chosen by a developer when creating a custom validation rule. For modeless errors, the validation permits the user to proceed.

With respect to the dialog box at block 326, the user can dismiss the dialog. Once the dialog is dismissed, the validation rolls back the invalid entry and enables the user to continue editing the electronic form. This editing can include re-inputting data into the data-entry field (block 328), or editing another data-entry field. Alternatively, the validation leaves the error in the document, but will not allow the user to continue editing the document without first correcting the error.

In the block 326, the validation presents an alert to notify the user of the invalid entry. This alert is intended to inform the user that the error is important and must be fixed. The alert does not have to be a pop-up window, but should be obvious enough to provide the user with an easy-to-notice notification that the user has entered data causing an error. The alert, in one implementation, is a pop-up window that requires the user to pause in the editing of the electronic form by making the user click on an “OK” button in the alert. This stops the user mentally, helping the user to notice that he must fix the data-entry field having the error before proceeding. The alert can contain no, little, or extensive information about the error. The information can be presented automatically or after the system receives a request for the information.

FIG. 4 shows the partially filled-in expense report 410 electronic form with a date dialog box 402 in an alert area display and arising from invalid data causing a modal error. The dialog box contains a button marked “OK” that the user must select (a date dialog button 404). The date dialog box 412 also contains a date information line 406 informing the user about the error, “The Report Date Must Be Later Than the Expense Period.” This information is intended to aid the user's attempt to correct the invalid data.

After presenting the user with some sort of alert in block 326, the validation enables the user to re-input data into the data-entry field containing the modal error (block 328). Here the user must change the data within the data-entry field to a valid or modeless error before continuing to edit new data-entry fields in the electronic form. Once the user inputs new (or the same) data into the data-entry field, the system receives the data at the block 314 and so forth. To proceed, the user must enter data that is not a modal error; if the user does not, the system will follow the process 300, continuing to find the data modally invalid and not permit the user to continue.

If the determination of the query at block 322 finds that the invalid data entered into the data-entry field is a modeless error, process 300 moves to block 324. Continuing the previous example, assume that the data entered into the report date data-entry field 412 is invalid. Assume also that “Jan. 27, 2002” is not defined to be a modal error. (Modal errors are those for which the validation rolls back the invalid entry requiring the user to re-enter another entry before continuing on to edit another data-entry field or requires the user to correct.) Thus, in this example, “Jan. 27, 2002”, is invalid, but is a modeless error.

In the block 324, the validation can alert the user of a modeless error by marking the data-entry field as containing an error, but allows the user to continue editing the electronic form. To make the editing process as easy, intuitive, and efficient as possible, the validation can mark the data-entry field from which the invalid error was entered in many helpful ways. The validation can highlight the error in the data-entry field, such as with a red box, a dashed red box, a colored underline, a squiggly underline, shading, and the like. The validation can also alert the user with a dialog box in a pop-up window, either automatically or only if the user asks for information about the error. After the data-entry field is marked in the user interface at block 324, process 300 returns to block 304 for further processing as described above.

Through this process 300 of FIG. 3, the system can receive and validate feature rich data in real-time. By so doing, a user can easily, accurately, and efficiently edit a structured data file (e.g., a markup language file such as an XML file) through entry of data into data-entry fields in an electronic form.

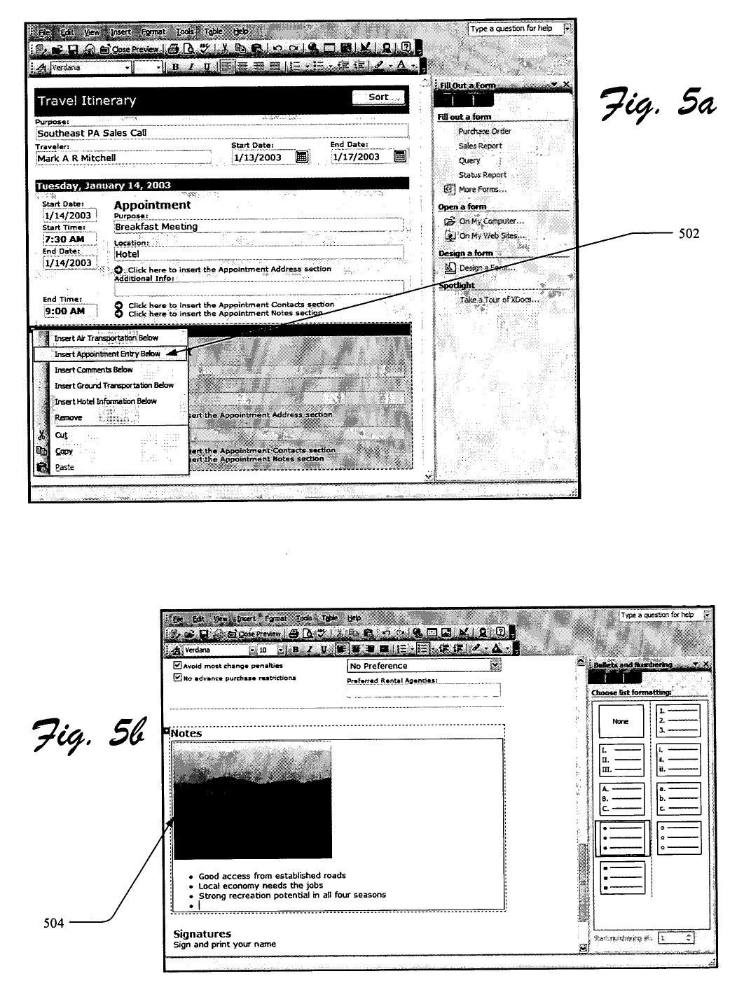

FIG. 5a shows a display of a filled-in travel itinerary electronic form where one appointment has been entered. The user ‘right clicks’ the mouse input device while the cursor position is within the “white space” in a highlighted or ‘selected’ repeating section that corresponds to a series of data-entry fields for entering another appointment. Because an unlimited number of appointments can be entered on the expense report electronic form, the appointment data-entry fields are considered to be a repeating section. The right click action by the user brings up a menu of several menu items 502. This particular menu is brought up due to the context of where the cursor position was located at the time that the right click action was initiated. As such, the user's data entry experience is sensitive to the context of the location of the cursor position or an insertion point at which the user can insert data.

The user moves down the displayed menu items to select the choice that will place the data-entry fields for the new appointment so as to be below the previously entered appointment. As such, the user interface face supports the addition of repeating sections above or below other repeating sections. The concept of the insertion of repeating section corresponds to a schema for a hierarchical data file into which data entered into the travel itinerary electronic form will be stored. For instance, such a hierarchical data file is seen at reference numeral 102 in FIG. 1.

FIG. 5b shows a display of a different view of the travel itinerary electronic form of FIG. 5a, where a user has entered richly formatted data into a “notes” data-entry field 504. The richly formatted data include a graphical image and several bulleted items. The concept of the availability of richly formatted data to be entered into a data-entry field corresponds to a schema for a hierarchical data file into which data can be entered into the travel itinerary electronic form will be stored.

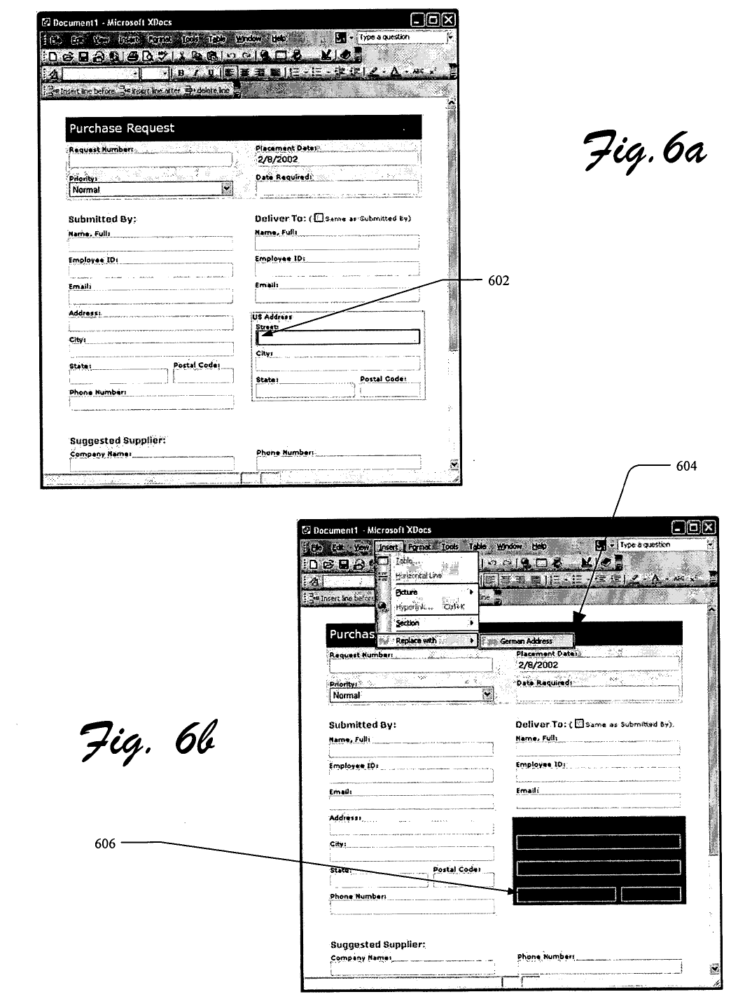

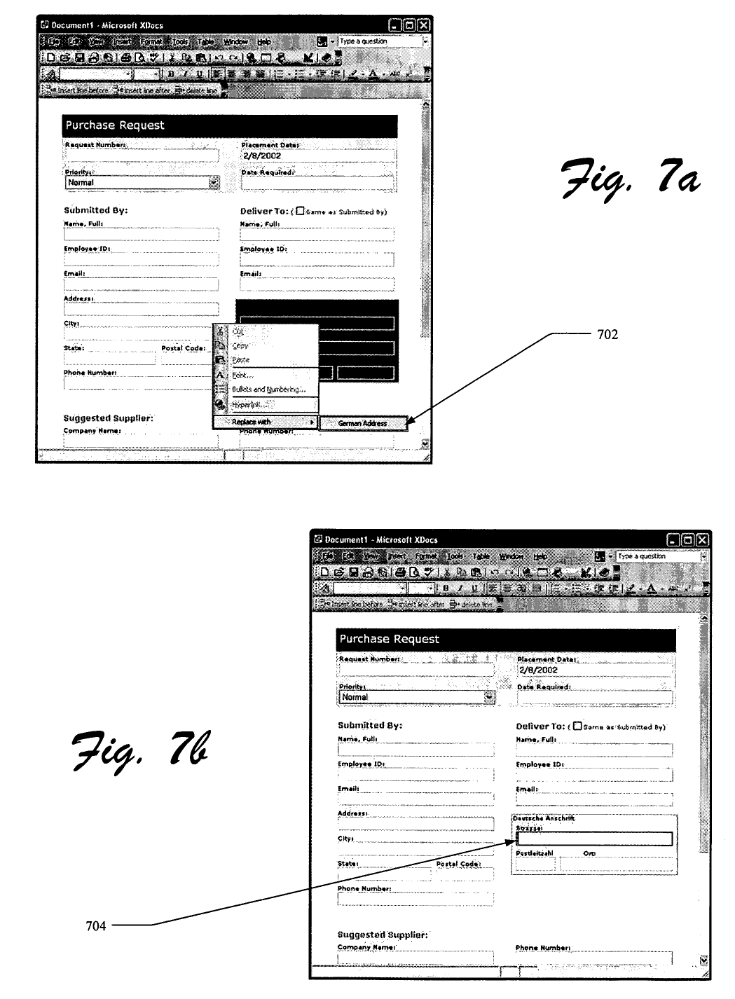

FIGS. 6a, 6b, 6a, and 7b show respective displays of a purchase request electronic form having a plurality of data-entry fields. One such data-entry field is a delivery address section that includes an address block. In FIG. 6a, the address block has a street field 602 in which an insertion point or cursor position is situated. The address block can come with different choices, like a US address or a German address. When a markup language document corresponding to the purchase request electronic form initially loads, the choice of the US address is the default that is displayed. The user fills out the purchase request electronic form and comes to the delivery address section. Since the delivery goes to Germany, the user wants to change the address format. The user now has two options on how to change the address block.

The user can select the address block as whole and use the “Insert/Replace with” menu items or the user can right click with the user's mouse on the white space in the address block which selects the address block as well as brings up the context menu seen in FIG. 6b. FIG. 6b shows that the address block is selected as a whole. The user now goes to the ‘insert’ menu and finds a fly out menu named “Replace with”. The fly out contains, in this case, one entry titled “German Address” 604. If the user picks German Address 604, the current address block is removed and the new address block inserted as shown in FIG. 7b.

In FIG. 7a, the user has right clicked in the white space of the address block. The right click action by the user, in the context of the cursor being within the address block, will select the address block as a whole and surface the context menu. This context menu now contains the same “Replace with” fly out menu. If the user picks German Address 702, the current block is removed and the new block inserted as shown in FIG. 7b. The concept of the availability of replaceable blocks, and menu options defining the same with respect to the context of the cursor position, can be declaratively specified in a solution for a hierarchical data file into which data entered into the purchase request report electronic form will be stored.

Exemplary Architecture

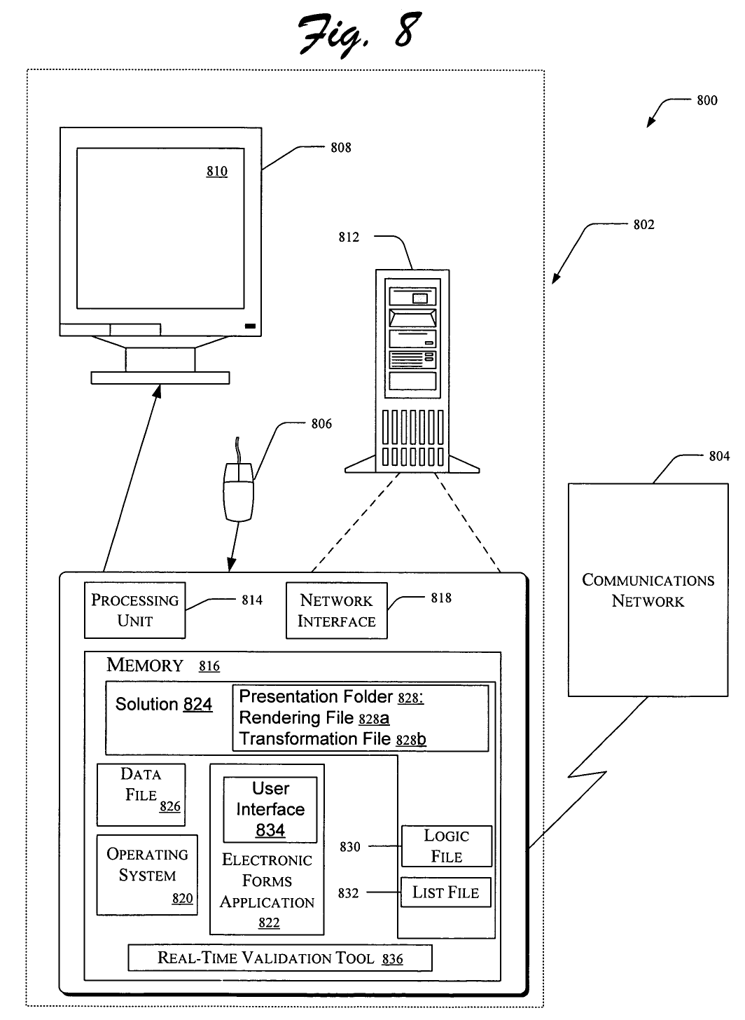

FIG. 8 shows an exemplary architecture 800 to facilitate feature-rich online and offline word processor-like editing of data files. This architecture 800 includes a computing system 802 connected to a communications network 804. The system 802 is configured to go online and communicate via the communications network 804 to gain access to non-local information sources, such as sources on an intranet or global network. Alternatively, the system 802 can remain offline, where it utilizes local resources without communicating over the communications network 804.

The computing system 802 includes a user-input device 806, a display 808 having a screen 810, and a computer 812. The user-input device 806 can include any device allowing a computer to receive a user's preferences, such as a keyboard, a mouse, a touch screen, a voice-activated input device, a track ball, and the like. With the user-input device 806, a user can edit a data file by adding or deleting information within a data-entry field on an electronic form, for instance. The user can use the display 808 and the electronic form on screen 810 to view the data files. An electronic form, with respect implementations of the electronic forms application 822 described herein, is a document with a set of controls into which users can enter information. Electronic forms can contain controls that have rich features such as rich text boxes, date pickers, optional and repeating sections, data validation, and conditional formatting.

The computer 812 includes a processing unit 814 to execute applications, a memory 816 containing applications and files, and a network interface 818 to facilitate communication with the communications network 804. The memory 816 includes volatile and non-volatile memory, and applications, such as an operating system 820 and the electronic forms application 822. The memory 816 also includes a solution 824 for a data file 826. The solution 824 is located locally in the memory 816, but often has a different original source, such as a source on the communications network 804. The solution 824 contains one or more files and folders, such as a presentation folder 828, a logic file 830, and a list file 832. The presentation folder 828 includes a rendering file 828a and transformation file 828b. The components of solution 824 will be discussed in greater detail below.

The electronic forms application 822 facilitates offline editing of the data files 826 and is executed by the processing unit 814. The electronic forms application 822 is capable of acting as a host application and enabling a user to open the data file 826 without actively finding and installing the data file's solution 824. Without any user interaction, other than the user attempting to open the data file 826, the electronic forms application 822 discovers and installs the data file's solution 824. Thus, the user does not have to do anything but request to open the data file 826. The user does not have to discover the data file's solution 824. The user does not have to install the data file's solution 824. This silent discovery and deployment allows the user to view, edit, and otherwise interact with the data file 826 with just a single request. In addition, the electronic forms application 822 can provide security offline similar to the security that the user typically enjoys when running a solution online.

A view of the data file 826 can be depicted on screen 810 through execution of the data file's solution 824. The solution 824 contains one or more applications and/or files that the electronic forms application 822 uses to enable a user to edit the data file 826. To edit the data file 826 in a user-friendly way, the data file's solution 824 contains the presentation folder 828, which includes an electronic form. This presentation folder 828 is a container for components that, when used, give the user a graphical, visual representation of data-entry fields showing previously entered data or blank data-entry fields into which the user can enter data. Data files often have one solution but each solution often governs multiple data files.

The travel itinerary electronic form 100 seen in FIG. 1 can be generated by the solution 824. The data-entry fields in travel itinerary electronic form 100 map to the data file 826, so that the data entered into the travel itinerary electronic form 100 is retained in the data file 826. FIG. 2 shows a graphical representation of the data file 826 as a data file tree 202 that shows icons representing nodes of the data file 826. Many of these nodes correlate to data-entry fields shown in the travel itinerary rendered form 100. Data entered into the data-entry fields can be stored in the data file 826.

The solution 824 presents the travel itinerary form 100 but also contains the logic file 830 that governs various aspects of the travel itinerary form 100 and the data file 826. The logic file 830 of the solution 824, with a real-time validation tool 836, validates and controls the user's data entry experience, including rejecting invalid data entry and diagnostics informing the user of data entry problems, such as with a sound, flashing error signal, pop-window, or the like. As such, the user can be precluded, in real-time, from entering data into a second data-entry field until valid data has been entered into a first data-entry field. The logic file 830 and real-time validation tool 836 are employed in the solution 824 to ensure that the right kind of data is being entered and retained by the data file 826. The logic file 830 can be internal to the solution 824, or can be implied from the data file 826 even if the data file 826 is primarily data. The logic file 830 can also be a schema, such as an XML schema. Here, the XML schema is a formal specification, written in XML, that defines the structure of an XML document, including element names and rich data types, which elements can appear in combination, and which attributes are available for each element.

In one implementation, the electronic forms application 822 enables an end user to input data into a data-entry field that is subordinate to and/or governed by a hierarchically greater data-entry field, an example of which is described above with respect to FIG. 5a. To do so, the user can direct a mouse-pointer beneath, below, within, or otherwise relative to the hierarchically greater data-entry field. The electronic forms application 822, in this implementation, will then display the electronic form with subordination areas reflecting these two data-entry fields to graphically indicate the way that they are respectively governed or are subordinate one to another. Some data-entry fields inherently contain other data-entry fields, and so are shown with subordination areas containing the data-entry fields in the display area 810; some data-entry fields are altered so that they are displayed so as to contain other data-entry fields.

The system 802 enables selection of a data-entry field that is displayed in the electronic form. The electronic form can also be a rendered form. Selection can be made using conventional user interface techniques, such as a computer mouse pointer, a stylus, a touch screen, or some other input mechanism that facilitates selection of a specific data-entry field. The end user can select a data-entry field by clicking on (or tapping, or otherwise identifying) the displayed areas (e.g., the white space) of the data-entry field, or on an icon or text name representing the data-entry field.

The electronic forms application 822 uses the solution 824 to enable a user to enter information into the operable fields (data-entry fields) of the electronic form. The solution 824 defines the availability of one or more actions to the user when entering the information into each data-entry field. The availability of the one or more actions to the user can concur in the context of any of several different events, which events can be typical of data entry in a word process application. For instance, the event can be an association of an input device being used by the user with an operable field; a cursor position corresponding to an input device being used by the user is proximal to an operable field; a data-entry field is selected by the user by use of an input device; a data-entry field on the electronic form is made to be an active (e.g., user-selected) field by operation of an input device being used by the user; a specific condition is met or not met; specific conditions are met or not with respect to the data in a data-entry field; when the user's mouse pointer for an input device rests over, within, or proximal to an editable region of a data-entry field; when the user's mouse pointer for an input device rests over, within, or proximal to an editable region of a data-entry field and the mouse is clicked one or more times, etc.

Given the foregoing, the actions that are available can be, for example, a request for a display of a menu or an activation of a menu item of a menu; a request for a display of a tool bar or an activation of a command tool of a tool bar; an editing operation with respect to data in a data-entry field that is an undo function, a redo function, a copy function, a cut function, a paste function, an insertion of a hyperlink, a carriage return or line feed function, etc. The available actions can also be performing a character formatting operation with respect to data in a data-entry field that is a boldface, an italics, an underlining, a change of font color or font size, character spacing or text effects. The available actions can additionally be adding, entering, updating or deleting, with respect to at least one data-entry field, a repeating operable field, an optional operable field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, or a time.

The examples of real-time data-entry, word processing techniques, and validation as described above and as applied for electronic forms application 822 are not intended to be limiting on the solution 824 or on the abilities of the system 802 or the real-time validation tool 836. Other types of electronic forms, word processing for data entry into data-entry fields of electronic forms, real-time validation techniques, and alerts can be used.

A solution can govern multiple data files. The exemplary travel itinerary form 100, for example, allows one or more users to fill out many different trips. Each time a user fills out a travel itinerary form 100, the system 802 can create a separate data file for that trip. Often, a user will create many different data files having the same solution. For each data file edited after the first, the system 802 is likely to have the appropriate solution stored in the memory 816. Thus, if a user previously opened a first data file and later attempts to open a second data file, both of which utilize the solution 824 for the travel itinerary electronic form 100, the electronic forms application 822 can silently discover and deploy the travel itinerary form 100 solution to enable the user to edit the second data file. How the electronic forms application 822 discovers and deploys solutions will be discussed in greater detail below.

A solution can be one file or contain many files, so long as the files used to edit data files it governs are included. The solution 824 of FIG. 8 includes the listing file 832, which is a manifest of all of the other files in the solution 824 and contains information helping the electronic forms application 822 to locate them. The logic file 830 and presentation folder 828 can be joined or separate. The presentation folder 828 helps the electronic forms application 822 present or give a view of a form enabling entry of data into the data file 826, such as a visual representation of the data file 826 by the travel itinerary form 100 electronic form. In some implementations, the presentation folder 828 includes a file that is an XSLT file, which, when applied to an XML data file, generates a XHTML (extensible Hyper-Text Markup Language) or HTML (Hyper-Text Markup Language) file. XHTML and HTML files can be used to show a view on the screen 810, such as the travel itinerary form electronic form 100 of FIG. 1.

A solution, such as the solution 824, can also include various files or compilations of files, including a manifest file setting forth names and locations for files that are part of the solution 824. The files within the solution 824 can be packaged together, or can be separate. When separate, the list file 832 acts as a manifest of the files within the solution 824. The list file 832 can also include other information, such as definitions, design time information, data source references, and the like. When the files are packaged together, the electronic forms application 822 can simply install and execute the packaged solution file for a particular data file. When not packaged, the electronic forms application 822 can read the list file 832, find the listed files, and install and execute each of the listed files for the particular data file. The list file 832 and the packaged solution file can be interrelated in that a packaged file contains the list file 832 and the list file 832 lists files packaged within the packaged file, although usually only one need be discovered by the system 802 to open a particular data file.

Like solutions, data files can come in various types and styles. As mentioned above, data files can be written in XML or some other mark-up language, or can be written in other languages. Most data files, however, do not contain extensive logic and other files or code. One of the benefits of having data files separate from their solutions is that it makes the data within them easier to mine for subsequent repurposing of the data for other uses. Because the data files are separate from their solution, the electronic forms application 822 makes them easy to open and edit by silently discovering and deploying the solution for the data file.

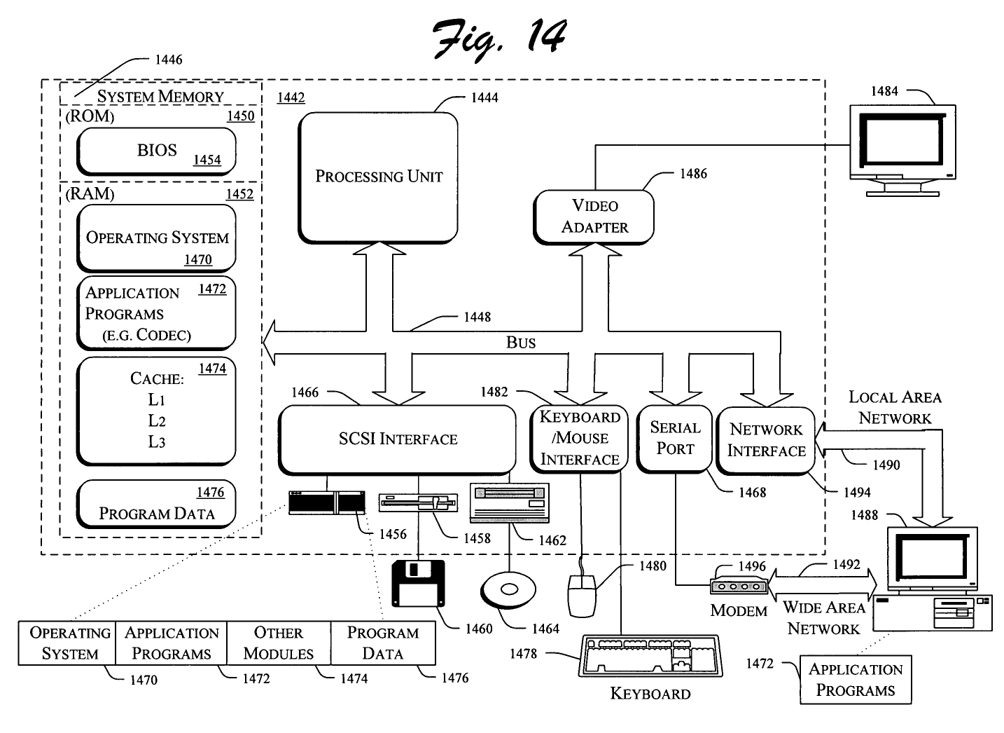

The above devices and applications are merely representative, and other known devices and applications may be substituted for or added to those shown in FIG. 8. One example of another known device that can be substituted for those shown in FIG. 8 is the device shown in FIG. 14.

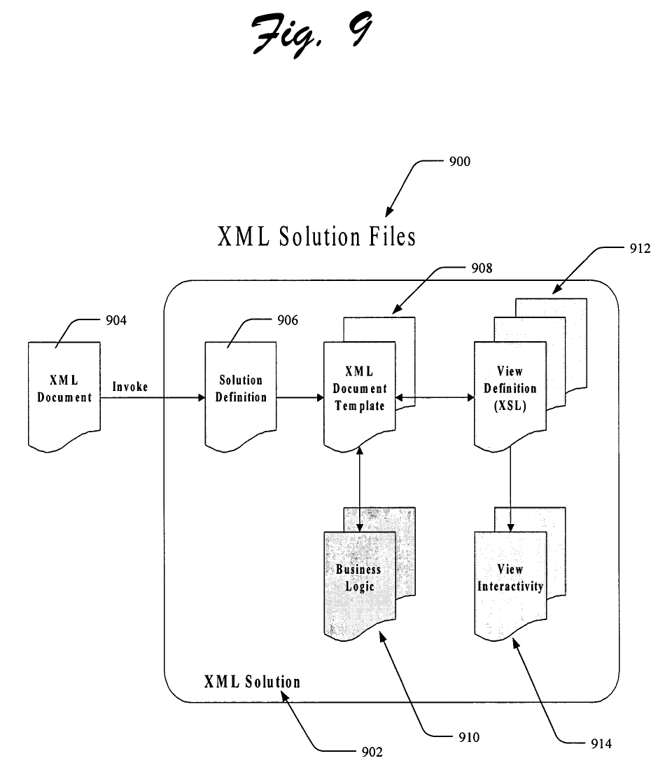

FIG. 9 depicts a variety of components that can be used by implementations of the electronic forms application 822 described herein. The electronic forms application 822 can be configured to do all, part, or none of, of allowing a user to design, view and complete an electronic form. The electronic forms application 822 also can be configured to allow the user to enter and change data in a data file corresponding to the electronic form, where the electronic form corresponds to the data file for which there is a corresponding solution.

A plurality of XML solution files 900, seen in FIG. 9, represent a collection of files that are used to implement an electronic form processed by implementation of the electronic forms application 822 described herein. File types can include HTML, XML, XSD, XSLT, script, and other file types that are necessary to support the functionality of the electronic form. As seen in FIG. 9, the XML solution files 900 include an XML solution 902 and an XML document 904. A solution definition file 906 is the “hub” of the electronic forms application 822. The solution definition file 906 contains a declarative definition of some solution features and a manifest of all the solution files including XML document templates 908, business logic files 910, view definition files 912, and view interactivity files 914. The XML document templates 908 are prototypes for each document type used in the electronic forms application 822. The XML document templates 908 are used to create new XML documents. Alternatively, an XML document template 908 can be a file that contains sample data that is displayed in the fields of an electronic form before a user fills out the electronic form. One of the XML document templates 908 can be identified in the solution definition file 906 as a default document for the electronic forms application 822. The business logic files 910 contain validation information associated with a XML document type, which is discussed above with respect to FIGS. 3-4. The view definition files 912 are XSL files associated with each XML document 904. The view definition files 912 define multiple layouts and view logic for the XML document 904. The view interactivity files define a contextual user interface (UI) as well as behavior of some XSL views, such as was described above with respect to FIGS. 6a-7b. Each XSL view is an electronic form-specific display setting that can be saved with an XML solution 902 and applied to form data when the electronic form is being filled out. Users can switch between views to choose the amount of data shown in the electronic form.

The information (e.g., data) that is collected in a single electronic form, further described herein, can be used by many different systems and processes. The usefulness of this information is due the storage of the information as XML. The electronic forms application 822 can communicate with ADO (ActiveX Data Objects) databases and XML Web services in a bi-directional manner, enabling the information stored in databases and servers to populate data-entry fields within electronic forms.

The solution definition file 906 can be configured to contain or refer to all the information to determine how the XML document 904 is presented to the end-user for editing of the information and ways to interact with the information, such as by navigating to different views of the information, modifying content or creating new content, etc. The solution definition file 906 can reference secondary files, some of which have types of data corresponding to XML standards, like XSD files that are used for schema information, like XSLT files that are used to specify the direct visual presentation of the XML data as views, and like XSLT style sheets that are used to transform the XML document that has been loaded into XHTML for visual presentation.

The solution definition file 906 uses XML vocabulary in an interoperable file format for XML solution 902. A declarative specification for contextual interactivity with XML data, via an XSL generated view, is included in the solution definition file 906. Additionally, the solution definition file 906 contains or references information about all other files and components used within a form, including files that contain instructions for user interface customizations, XML schemas, views, business logic, events, and deployment settings. Here, an event is an action recognized by an object, such as a mouse click or key press, for which a response by the electronic forms application 822 can be defined. An event can be caused by a user action or an executed Visual Basic statement, or it can be triggered by the system.

The solution definition file 906 is an XML document that can also express information that does not correspond to any XML standard via an XML syntax that allows declarative specification of XML solution 902. Various features can be provided to the end-user by the solution definition file 906.

One feature that is provided by the solution definition file 906 is the ability to define views and commands/actions that can be made available via secondary user interface as well as how the views' availability will be determined contextually, including the interactivity that is to be made available in the views. Here, the secondary user interface (UI) referred to is a context driven UI that offers menus and toolbars. Another feature provided by the solution definition file 906 is the types of binding between the views and the underlying XML data so that data entered can be saved in an XML file. The binding here refers to a logical connection from a control (e.g., a data entry field on an electronic form) to a field or group in a data source of an data file so that data entered into the control is saved. Here, a data source is a collection of fields and groups that define and store the data for an electronic form being processed with the electronic forms application 822. Specifically, a control is a graphical user interface object, such as a text box, check box, scroll bar, or command button, that lets users control the electronic forms application 822. Controls can be used to display data or choices, perform an action, or make the user interface easier to read. Conversely, when a control is unbound, it is not connected to a field or group, and so data entered into the control will not be saved. A still further feature is the availability of structural or text-level editing operations on the XML data. Yet another feature includes validations (e.g., XML data validation), event handlers associated with the electronic form as a whole, and business logic associated to individual nodes of the XML Document Object Model (DOM) representing the form, where the business logic attaches to the electronic form as a whole, including the association of ‘business logic’ script with user actions. A still further feature includes simple workflow and information about routing of the XML Document 904. The availability to use global metadata information about the XML Document 904, including deployment/publishing information, is another feature. Another feature provided by the solution definition file 906 is the availability of default XML data that can be used when creating a new XML Document 904. A unique identifier for the electronic form is an other feature. A still further feature is the availability of optional schema for the XML DOM that comprises the electronic form.

The electronic forms application 822 described herein enables users to process XML documents 904. XML documents 904 are partitioned into classes or document types, based on their schemas. XML documents 904 need business logic 910 and data flow as required by the XML data solution 902 they are a part of. This business logic 910 and data flow information lives outside of the XML document 904 in XML solutions 902. As such, the XML solution 902 is a factory for given classes of XML Documents 904. The XML solution 902 defines the layouts and the editing behavior of the XML Documents 904. The XML solution 902 enforces data consistency and provides routing information. The electronic forms application 822 described herein may work with one or more types of XML documents 904 and provide a portal and a list views for collection of XML documents 904. XML solutions 902 can be stored on the client, such as in computer 812, and can be made available offline.

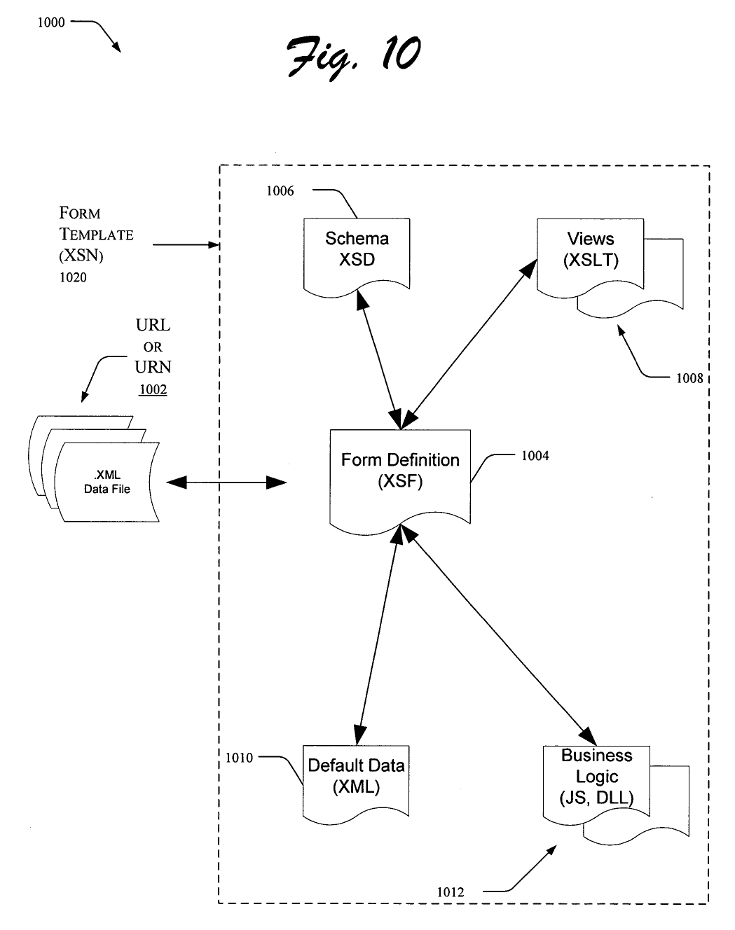

FIG. 10 depicts an example of several files that make up or are referred to by an electronic form template 1020. The electronic form template 1020 can be a manifest of all files used by the electronic forms application 822 described herein. The electronic form template 1020 can be invoked when a user navigates to an XML document or when a new XML document is to be created. The electronic form template 1020 is a collection of files that declaratively defines the layout and functionality for an electronic form. Electronic form templates 1020 can be stored either as a single compressed file (e.g., with an “*.xsn” extension) or as a folder of files. This collection of files can be used in conjunction with any XML document to be opened and filled out with implementations of the electronic forms application 822. The electronic form template 1020 includes an XML schema definition 1006, a form definition 1004, and one or more XSLT filed 1008 for defining views.

The XML schema file 1006 defines the structure for the XML created when filling out the electronic form. The one or more XSLT files 1008 define different views hat a user can see on a display. The definition of different views can be written in a language, such as XSLT, that is used to transform XML documents into other types of documents, such as HTML or XML. The XSLT is designed for use as part of XSL that has an XML vocabulary for specifying formatting semantics. An XSL style sheet specifies the presentation of a class of XML documents by describing how an instance of the class is transformed into an XML document that uses the formatting vocabulary. The XML file 1004 (with an .xsf extension), which corresponds to the solution definition 906 seen in FIG. 9, defines much of the structured editing functionality behind the form template.

Optional auxiliary files 1012 (e.g., Jscript or VBscript, graphics, XSLTs) define merge functionality, and/or other resources needed by the form template). An XML data file 1002 corresponds to a URL or an URN for the purposes of reference with respect to the electronic form template 1020. An XML file 1010 can be used to determine the structure and content of a blank electronic form created with the form template. A collection of default data in XML file 1010 is included in the electronic form template 1020 and includes data for creating a new (e.g., blank) electronic form. One or more files of business logic 1012, corresponding to business logic 910 seen in FIG. 9, can also be included in the electronic form template 1020. The business logic 1012 can be written in one or more languages including Java Script (JS) or languages used for components of a data link library (DLL). As seen in FIG. 10, each file in the form template 1020 is referenced from and to the form definition 1004.

As with HTML files, opening an .xml file in the Microsoft® Windows® operating system will automatically launch the application that created the file. If the Microsoft® Windows® operating system cannot detect the application that created the file, it will launch the file in the default application registered for the XML file extension. When an XML file is created or edited using the electronic forms application 822, the electronic forms application 822 creates an XML processing instruction (PI) at the beginning of that XML file, which indicates that the document should be edited specifically with the electronic forms application 822. Advantageously, the PI is part of the XML standard and does not interfere with the schema on which the XML file may be based. XML files generated by the electronic forms application 822 include the XML processing instruction that identifies the corresponding template using either a URL or a URN.

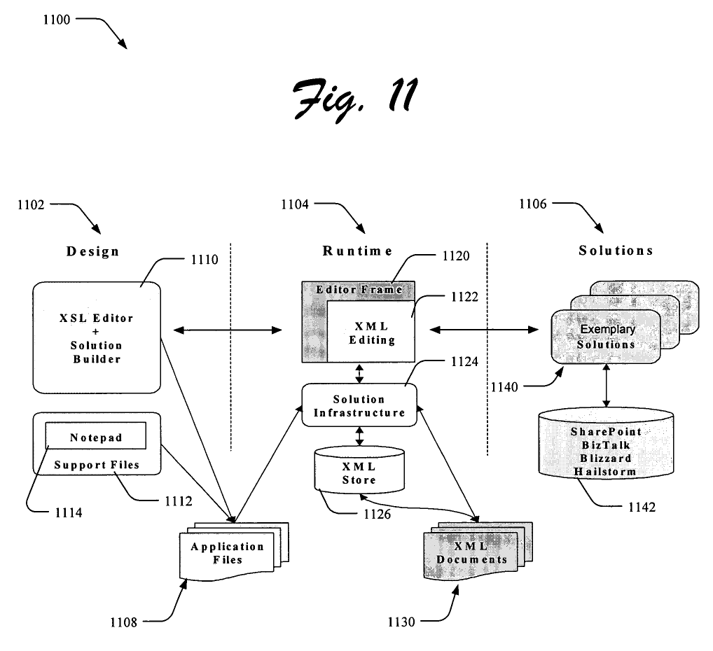

FIG. 11 shows an exemplary architecture 1100 for implementations of the electronic forms application 822 described herein. The architecture 1100 includes a solution design component 1102 for building a solution corresponding to a data file for which an electronic form can be used, an XML runtime component 1104 to enter and view data in the electronic form, and a several exemplary XML solutions 1106. Each of the components of the architecture 1100 will now be discussed.

The solution design component 1102 of the architecture 1100, such as is seen at reference numeral 902 in FIG. 9, allows a solution to be built. The solution design component 1102 provides a user interface (UI) to handle all the design requirements for common XML solutions. The result of the solution design component 1102 is the set of files that represent the XML solution 902. The XML solution 902 can be used to declaratively define the output of the solution design component 1102. Included in the solution design component 1102 are an XSL editor and solution builder 1110 and supporting files 1112 that include a notepad 1114. Notepad 1114 is useful for entering script for data validation routines. The supporting files 1112 communicate with one or more application files 1108 that are useful in building a solution for a data file.

The runtime component 1104 includes an editor frame 1120 that includes XML editing 1122. The XML editing 1122 can function similarly to the electronic forms application 822. The editor frame 1120 bidirectionally communicates with a solution infrastructure 1124, such as XML solution 902 seen in FIG. 9. The solution infrastructure 1124 communicates with an XML store 1116. Each of the solution infrastructure 1124 and the XML store 1116 bidirectionally communicates with one of more XML documents 1130. Additionally, the solution infrastructure 1124 communicates with the one or more application files 1108. As seen in FIG. 9, the XML document 904 points to the solution definition 906 that should process the XML document 904 on the computer 812. When the user uses the computer 812 to navigate to the XML document 904, the solution infrastructure 1124 loads the required the solution definition 906. If needed, the solution definition 906 handles any contextual user interfaces (UI), runs business logic associated with the XML document 904 (e.g., business logic 910, 412), controls data subscriptions for computer 812, creates local folders, searches and filters the local folders, and enforces security for all computer 812 operations. For some data operations, the XML solution infrastructure 1124 works with the local XML store 1126. The local XML store 1126 can provide electronic mail (e-mail) capabilities, such as an “inbox” and a “sent items folder” for XML payloads, and to enable the ordering, filtering and aggregation of XML data that is shredded or parsed in the local XML store 1126. The XML solution infrastructure 1124 allows a user of computer 812 to access various XML data sources on computer 812, in an intranet, as well as on an extranet or the World Wide Web. Given the foregoing, XML Documents 1130 can be displayed and edited using the XML Editing 1122 of the editor frame 1120.

The solutions 1106 can be provided to a user of computer 812 as part of the architecture 1100, where the user would like to see samples or exemplary solutions from which the user can learn about the use and operation of electronic forms application 822. Solutions 1106 can provide the user with a guide for customizing electronic forms and for building new solutions based on the exemplary solutions.

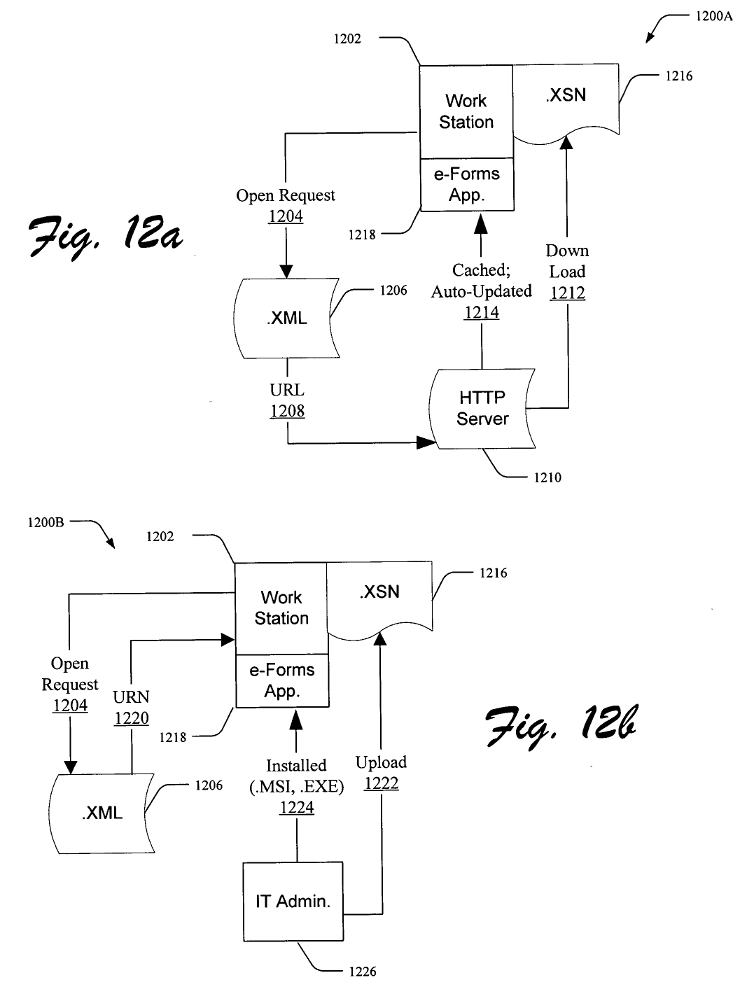

FIGS. 12a and 12b provide respective processes 1200A, 1200B by which a user of workstation 1202 can be provided with a solution having a corresponding electronic form that can be used by a user via an electronic forms application 1218. The electronic forms application 1218 and the workstation 1202 seen in FIGS. 12a-12b can be similar to the electronic forms application 822 and the computer 812, respectively, as seen in FIG. 1. For instance, one of the form templates 1020 seen in FIG. 10 can be deployed to workstation 1202 so that the user of workstation 1202 can fill out the electronic form that corresponds to the form template 1020. As discussed with respect to FIG. 10, the form template 1020 includes the XML schema that is to be used, the formatting or presentation of the electronic form, and any logic that the electronic form uses. The deployment of the form template 1020 is available by process 1200A and process 1200B.

In process 1200A, seen in FIG. 12a, the form template 1020 is deployed to a HTTP server 1210 (e.g., a Web Server). This deployment of the form template 1020 enables a transparent web deployment and maintenance model. Specifically, at block 1202 of FIG. 12A, a user opens a form of a certain type for the first time via an open request 1204 for an XML document 1206 using a URL 1208. The previously stored corresponding form template 1020 is deployed from HTTP server 1210 at a process flow 1214. The deployed form template 1020 is automatically downloaded on a network and stored as an “*.XSN” file on the workstation 1202 being used by the user. The downloaded form template 1020 allows the user to use the form template 1020 even when the workstation 1202 is not connected to the network. Assuming the user has network connectivity, whenever the user opens a form, the electronic forms application 1218 can be configured to check to see if a newer version of the corresponding form template 1020 is available at a process flow 1214. If so, the newer version can be automatically downloaded to and stored on the users' workstation 1202 at a process flow 1214.

Process 1200B, seen in FIG. 12b, is an alternative to process 1200A in that the form template 1020 can be deployed by a process flow 1224 directly to workstation 1202 from an information technology administrator 1226 in such a way that the form template 1020 will have access to local system resources and/or applications. In this case, the deployed form template 1020 can be packaged for execution via process flow 1224 (e.g., a “*.exe” or “*.msi” file). As seen in FIG. 12b, the workstation 1202 navigates to an XML file 1206 and issues an open file request at a process flow 1204. A URN is returned to workstation 1202 at a process flow 1220. Here, for instance, the form template 1020 can access a directory service to obtain a users' role in an organization, where users are required to be at a certain management level to approve an electronic form, such as a travel itinerary, a purchase request or other document used in the ordinary course of business. Once obtained, the electronic forms application 1218 can use this information to execute the appropriate business logic for the purchase request. The form template 1020 may be deployed, for instance, along with other client code as part of a larger client deployment scenario.

Techniques for Silent Discovery and Deployment of a Solution for a Data File

Overview

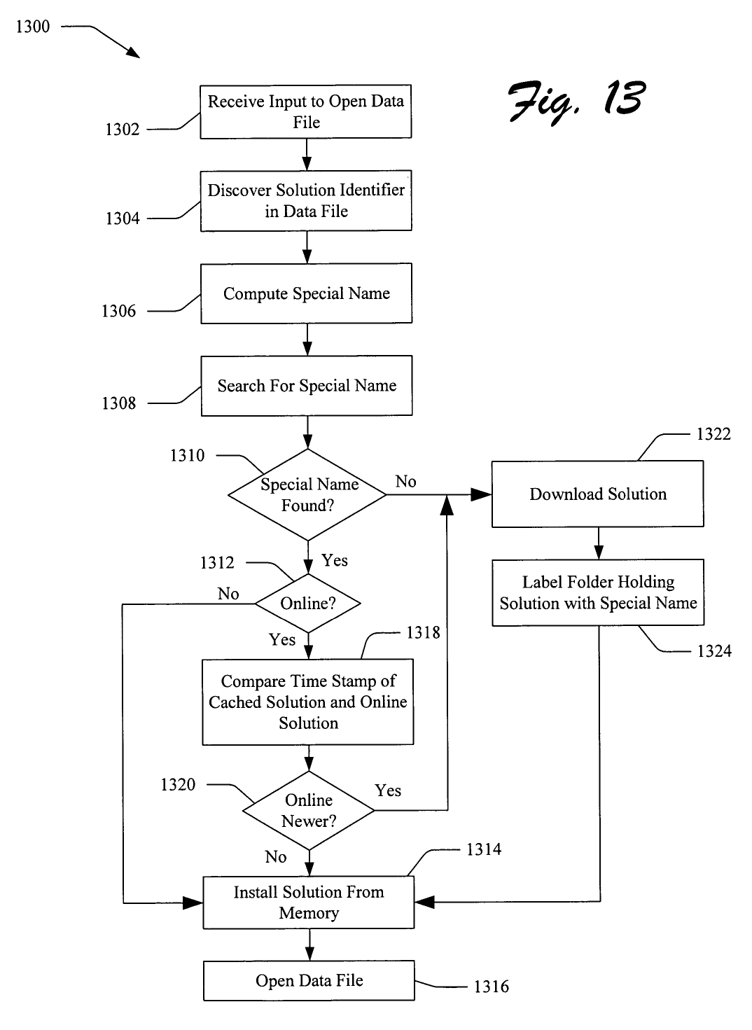

FIG. 13 shows an exemplary process 1300 for silently discovering and deploying a data file's solution. The process 1300 is illustrated as a series of blocks representing individual operations or acts performed by the architecture 100. The process 1300 may be implemented in any suitable hardware, software, firmware, or combination thereof. In the case of software and firmware, the process 1300 represents a set of operations implemented as computer-executable instructions stored in memory and executable by one or more processors.

Silent Discovery and Deployment

At block 1302, the system 802 receives input from a user to open the data file 826. The user may simply click on an icon representing the data file 826 or otherwise select the data file 826 after which the system 802 opens the data file 826.

At block 1304, the system 802 discovers a solution identifier in the selected data file 826. This assumes that the data file 826 is one that the electronic forms application 822 is capable of reading. The electronic forms application 822 can read data files created at some previous time by the user's or another's electronic forms application 822. In one implementation, the electronic forms application 822 can also read the data file 826 if it is created by another application that builds a solution identifier into the data file 826. This solution identifier can give the system 802 an original source for the solution 824. The solution identifier is typically a URL (Uniform Resource Locator) or URN (Uniform Resource Name), but can include other types of names and/or locators. URLs give locations and URNs names of resources, such as the solution 824, which are typically accessible through the communications network 804. With the solution identifier, the system 802 can determine the original source for the solution 824 (where it first came from) and whether or not the system 802 has seen the solution 824 before.

In one implementation, the solution identifier is part of a processing instruction included within the data file 826. This processing instruction is often part of data files and can include various instructions to host applications, such as the electronic forms application 822. Processing instructions, while not strictly data, do not rise to the level of an applet or application typically included in a solution 824 for a data file 826. For data files written in XML, for instance, the processing instructions are usually not written in XML, but rather are just a piece of information commonly included. A processing instruction in an XML data file can look like:

“<? mso-infoPathSolution solutionVersion=“1.0.0.7” PIVersion=“1.0.0.0” href=“http://xdsp04-neten/MiladinP/Forms/template.xsn”?>”.

This processing instruction gives the electronic forms application 822 a solution identifier, which here gives the original source for the solution 824 for the data file 826. This solution identifier includes a URL indicating that the original location for the solution 824 is at a remote server accessible by accessing the communications network 804 through the network interface 818.

One of the advantages of the electronic forms application 822 is that it enables a user to open the data file 826 without the user needing to discover the data file's solution 824, install the solution 824, or even know that the solution 824 exists. The disclosed implementations enable users to open data files simply and easily and in many cases enables them to edit a data file offline that they would otherwise not have been able to edit.

With the solution identifier, the system 802 computes a special name for the solution 824 (block 1306). This special name is designed to be a name easily found only by the electronic forms application 822. The special name, because it is computed and findable by the electronic forms application 822 but is not intended to be discoverable by other applications, allows for greater security in downloading possibly hostile solutions from the communications network 804.

In one implementation, the electronic forms application 822 takes the solution identifier and computes a unique special name for the solution identifier. This unique special name is repeatable; the next time the electronic forms application 822 computes a unique special name for the same solution identifier, the same unique special name will be created. By so doing, the electronic forms application 822 can find a previously downloaded solution by computing the unique, special name and then search for the unique, special name to determine if the solution is available locally for offline use (such as by having the solution stored in the memory 816).

In another implementation, the electronic forms application 822 computes a unique special name by computing a hash, such as a Message Digest 5 hash (MD5 hash), of the solution identifier. By computing a one-way hash of the solution identifier, the electronic forms application 822 creates a unique, special name that is a file of 128 bits from the digits of the solution identifier. Because the file of the unique, special name is 128 bits long, it is very difficult for another application, such as one designed to damage a computer or its files, to determine if the solution 824 is on the computer (cached or available offline) and access the solution 824. With this hash-based special name, the electronic forms application 822 provides additional security for the system 802.

The system 802 uses the special name, which corresponds to a solution identifier and thus the data file 826's solution 824, to search through locally accessible sources for the solution 824 (block 1308). The system 802 may, for instance, search in the memory 816 of FIG. 1 for files and/or folders with the same name as the special name computed in the block 1306.

When the Special Name is Found

If the system 802 finds the special name (i.e., the “Yes” branch from block 1310), then the solution 824 was saved earlier in the system 802 that was searched locally in the block 1308. Thus, when the special name is found, the system 802 knows that the solution 824 referred to in the data file 826 (which the user is attempting to open) is accessible offline by the system 802. The solution 824 is usually stored in the memory 816 but can be stored in other searchable, local sources that the system 802 does not have to go online to find.

The solution 824, stored at the source and found using the special name, may not be current, however. Because of this, the system 802 determines whether or not the system 802 is online or offline (block 1312). If online (i.e., the “Yes” branch from block 1312), the system 802 will attempt to determine whether or not a more up-to-date solution should be installed (discussed below); if offline, the system 802 will proceed to install the locally stored solution 824 (block 1314).

If the Solution is Found and the System is Offline

If the solution 824 is found and the system 802 is offline, the system 802 proceeds to install the solution 824 from the memory 816 or another locally accessible source (block 1314).

The system 802 installs the solution 824 silently in that the user does not need to know that the solution 824 was discovered, found, or being installed. Thus, the system 802 enables a user to edit the data file 826 when offline by silently discovering and deploying the data file's solution 824.

In one implementation, the system 802 installs the solution 824 and then opens the data file 826 in such a manner as to mimic how the data file 826 would be opened had the user opened the data file 826 with the solution accessible online, such as through opening the data file 826 with Microsoft® Internet Explorer®. The system 802 does so to make opening and editing the data file 826 as comfortable for the user as possible, because many users are familiar with opening data files online. One possible difference, however, is that if the system 802 has a slow connection to the communications network 804, the electronic forms application 822, by installing the solution 824 from a local source like the memory 816, may more quickly open the data file 826 than if the user were online.

In block 1316, the system 802 opens the data file 826 to enable the user to edit the data file 826. One example of an opened data file (and solution) enabling edits is the travel itinerary form 100 of FIG. 1. In this example, the user is able to edit the data file 826 by adding, deleting, or changing data in data entry fields (like the data-entry field 106 even though offline.

Following the previous blocks, a user can easily open a data file offline without having to discover or deploy the data file's solution. This enables users, for example, after first opening a solution online, to open a data file offline. A user can open a data file online and edit it by adding a date through the data-entry field 102 of the travel itinerary form 100 and then stop editing the data file (the data file would contain the added date by the system 802 adding the date to the data file). The user could then go offline, such as by taking his or her laptop on a business trip, and complete filling out the electronic form. Or the user could send the partially filled-out data file to another user to fill out the rest of the electronic form, which the other user could do so long as the other user's system contains a stored solution. This flexibility allows users and businesses a greater ability to use information by keeping data and solutions separate and by allowing offline use of data files.

If the Solution is Found and the System is Online

Assuming the system 802 finds the special name and the system is online, the system 802 will attempt to determine whether the current solution is the most recent version or a more up-to-date solution is available. In block 1318, the system 802 compares the time stamp of the stored solution 824 and the online solution. Since the system 802 is online, it can access the solution (here we assume that the original origin of the solution 824 is from an online source). If the solution identifier from the data file 826 selected by the user contains a reference to the solution 824 being accessible online, the system 802 goes online to check whether or not the online solution is newer than the stored solution 824 (block 1320). In one implementation, the system 802 compares a time stamp of the online solution with a time stamp on the stored solution 824.

If the online solution is not newer (i.e., the “No” branch from block 1320), the system 802 proceeds to the block 1314, installing the stored solution 824. If the online solution is newer than the stored solution 824 (i.e., the “Yes” branch from block 1320), the system 802 either replaces the stored solution 824 with the online solution or otherwise updates the older, stored solution 824.

Downloading the Solution for Later Use

In block 1322, the architecture 800 (or the system 802 by accessing the communications network 804) downloads a solution into a locally accessible source such as the memory 816. The system 802 downloads this solution when the data file 826 selected by a user contains a solution identifier for a solution for which the system 802 does not have local access (such as it not being cached) or for which the system 802 has local access but the cached or stored version of the solution (the solution 824) is older than the online version.

In either case, the system 802 has already discovered the solution identifier for the solution and computed a special name for the solution. The system 802 then downloads the solution from the online source and saves it into a folder named with the special name (block 1324). If a solution already exists in that folder, the system 802 replaces it with the newer version or otherwise updates the currently cached solution. The resulting new or updated version will then be in the solution 824.

In one implementation, the system 802 saves the solution to a unique location within the system 802's accessible memory. The system 802 does so in cases where the system 802 is used by multiple users. By so doing, the system 802 is able to determine which of the users that use the system 802 or load files into memory locally accessible by the system 802 saved the particular solution. Also by so doing, the system 802 may provide greater security for the computer 812 and its users.

Data Files, Transformation Files, Rendering Files and Rendered Forms

As discussed above, solution 824 contains presentation folder 828 that includes the rendering file 828a and the transformation file 828b. The data file 826, transformation file 828a, rendering file 828b, and a rendered form work together to allow a user to edit the data file 826. A user can input data into and view data in the data file 826 through the rendered form of the data file. This rendered form is the result of executing the rendering file 828a, which is created by applying the transformation file 828b on the data file 826.

FIGS. 1, 2, 5a, and 5b show the rendered form 100 entitled “Travel Itinerary”, which is generated by executing the rendering file 828a. This travel itinerary rendered form 100 is rendered so as to contain data-entry fields in which a user can enter data. These data-entry fields map to the data file 826, so that the data entered into the form are retained in the data file 826.

Data input into a particular data-entry field of the rendered form 100 is stored in a particular node of the data file 826. Data-entry fields of the rendered form 100 correlate to nodes of the data file 826 in part because the rendered form 100 is the result of the transformation file 828b being applied on the data file 826. The system 802 can use various ways to detect which data-entry fields correlate to which nodes of the data file 826, including through mapping with XML Path Language (XPath) expressions that address parts of data file 826 (e.g., an XML document) by providing basic facilities for manipulation of strings, numbers and Booleans.

The transformation file 828b also correlates to the data file 826. Nodes of the data file 826 correlate to particular parts of the transformation file 828b, also called nodes for the purposes of this description. Thus, nodes of the transformation file 828b correlate to nodes of the data file 826. This correlation can arise from nodes of the transformation file 828b being mapped to the nodes of the data file 826, including through XPath expressions, or otherwise.

That certain nodes of the transformation file 828b correlate to certain nodes of the data file 826 is often not enough, however, for the system 802 to accurately reflect a change in a particular node of the data file 826 by simply applying only a particular node of the transformation file 828b on a particular node of the data file 826. A node of the transformation file 828b, when applied on a node of the data file 826, may affect many nodes of the data file 826, and example of which was described above with respect to FIGS. 1-4. There, the travel itinerary form 200 had the trip start date data-entry field 204 showing the data entered as “Mar. 13, 2002”. After the electronic forms application 822 produced a rendering file, the system 802 renders the rendering file. In this example, the transformation file 828b, when applied, affected other nodes of the data-entry field other than just the trip start date node 204, in this case an event start date node 202. Because the transformation file 828b (or a part thereof) affected the event start date node 202, the rendering file 828a included that change. Thus, when executed, the rendering file 828a renders an updated travel itinerary form 200, including the data shown in an event start date data-entry field 204 in FIG. 2. Here, the transformation file 828b altered the event start date node 802 to include the exact same data entered into the trip start date data-entry field 204 of FIG. 2. The transformation file 828b may perform such an action to make it easier for the user in cases where a future node/data-entry field is likely to have the same data.

Further, the node of the transformation file 828b may direct the system to perform computations or other operations using other resources, like a database. For these and other reasons, the electronic forms application 822 analyzes the results of nodes of the transformation file 828b being applied on nodes of the data file 826 or nodes of some hypothetical data file, which will be discussed in greater detail below.

In some implementations, the transformation file 828b is an XSLT (eXtensible Style-sheet Language Transformation) file, which, when applied to an XML data file 826, generates a XHTML (extensible Hyper-Text Machine Language) or HTML (Hyper-Text Machine Language) rendering file (such as the rendering file 828a). The transformation file 828b can also be an arbitrary XSLT file, such as a custom-made file or some other W3C-compliant file. XHTML and HTML files can be used to show a view on the screen 810, such as the electronic travel itinerary form seen in FIGS. 1, 2, 4, 5a and 5b.

Like transformation files, data files can come in various types and styles. Hierarchical data files can be written in XML or some other mark-up language, or can be written in other hierarchical languages. Hierarchical data files also are typically concise and data-centered so that the data they contain can be more easily accessed or manipulated by multiple software applications, including software not typically used in a solution, such as an application that searches for a particular type of data and compiles that data into a report. A non-typical application, for example, could be one that compiles a report of all of the travel itineraries filled out in electronic forms by a certain person by searching through and compiling the data entered in travel itinerary data files for a particular person.

The above devices and applications are merely representative, and other known devices and applications may be substituted for or added to those shown in FIG. 8. One example of another known device that can be substituted for those shown in FIG. 8 is the device shown in FIG. 14.

Exemplary Computing System and Environment

FIG. 14 shows an exemplary computer system and environment that can be used to implement the processes described herein. A computer 1442, which can be similar to computer 812 in FIG. 1, includes one or more processors or processing units 1444, a system memory 1446, and a bus 1448 that couples various system components including the system memory 1446 to processors 1444. The bus 1448 represents one or more of any of several types of bus structures, including a memory bus or memory controller, a peripheral bus, an accelerated graphics port, and a processor or local bus using any of a variety of bus architectures. The system memory 1446 includes read only memory (ROM) 1450 and random access memory (RAM) 1452. A basic input/output system (BIOS) 1454, containing the basic routines that help to transfer information between elements within computer 1442, such as during start-up, is stored in ROM 1450.

Computer 1442 further includes a hard disk drive 1456 for reading from and writing to a hard disk (not shown), a magnetic disk drive 1458 for reading from and writing to a removable magnetic disk 1460, and an optical disk drive 1462 for reading from or writing to a removable optical disk 1464 such as a CD ROM or other optical media. The hard disk drive 1456, magnetic disk drive 1458, and optical disk drive 1462 are connected to the bus 1448 by an SCSI interface 1466 or some other appropriate interface. The drives and their associated computer-readable media provide nonvolatile storage of computer-readable instructions, data structures, program modules and other data for computer 1442. Although the exemplary environment described herein employs a hard disk, a removable magnetic disk 1460 and a removable optical disk 1464, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 1456, magnetic disk 1460, optical disk 1464, ROM 1450, or RAM 1452, including an operating system 1470, one or more application programs 1472 (such as the electronic forms application 822), other program modules 1474, and program data 1476. A user may enter commands and information into computer 1442 through input devices such as a keyboard 1478 and a pointing device 1480. Other input devices (not shown) may include a microphone, joystick, game pad, satellite dish, scanner, or the like. These and other input devices are connected to the processing unit 1444 through an interface 1482 that is coupled to the bus 1448. A monitor 1484 or other type of display device is also connected to the bus 1448 via an interface, such as a video adapter 1486. In addition to the monitor, personal computers typically include other peripheral output devices (not shown) such as speakers and printers.

Computer 1442 commonly operates in a networked environment using logical connections to one or more remote computers, such as a remote computer 1488. The remote computer 1488 may be another personal computer, a server, a router, a network PC, a peer device or other common network node, and typically includes many or all of the elements described above relative to computer 1442. The logical connections depicted in FIG. 5 include a local area network (LAN) 1490 and a wide area network (WAN) 1492. Such networking environments are commonplace in offices, enterprise-wide computer networks, intranets, and the Internet.

When used in a LAN networking environment, computer 1442 is connected to the local network through a network interface or adapter 1494. When used in a WAN networking environment, computer 1442 typically includes a modem 1496 or other means for establishing communications over the wide area network 1492, such as the Internet. The modem 1496, which may be internal or external, is connected to the bus 1448 via a serial port interface 1468. In a networked environment, program modules depicted relative to the personal computer 1442, or portions thereof, may be stored in the remote memory storage device. It will be appreciated that the network connections shown are exemplary and other means of establishing a communications link between the computers may be used.

Generally, the data processors of computer 1442 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the blocks described below in conjunction with a microprocessor or other data processor. The invention also includes the computer itself when programmed according to the methods and techniques described herein.

For purposes of illustration, programs and other executable program components such as the operating system are illustrated herein as discrete blocks, although it is recognized that such programs and components reside at various times in different storage components of the computer, and are executed by the data processor(s) of the computer.

Conclusion

The above-described implementations enable a user to have a feature-rich data entry experience when editing a data file by discovering and deploying the data file's solution application. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving input to open a data file having a solution;
discovering, without user interaction, the solution;
deploying, without user interaction, the solution;
displaying, by opening the data file with the solution, an electronic form having operable fields; and
enabling a user to enter data into the operable fields of the electronic form, wherein the solution defines the availability of one or more actions to the user when entering the data into each said operable field of the electronic form.

2. The method as defined in claim 1, further comprising:
receiving data entered into the operable fields of the electronic form; and
altering the data in the data file so as to correspondingly reflect the data received.

3. The method as defined in claim 1, wherein the availability of one or more actions to the user concurs with an event elected from the group consisting of:
an association of an input device being used by the user with one said operable field;
a cursor position corresponding to an input device being used by the user is proximal to one said operable field;
one said operable field is selected by the user by use of an input device;
one said operable field on the electronic form is made to be an active field by operation of an input device being used by the user; specific conditions are met;
specific conditions are met with respect to the data in the one said operable field;
when the user's mouse pointer for an input device rests over, within, or proximal to an editable region of one said operable field;
when the user's mouse pointer for an input device rests over, within, or proximal to an editable region of one said operable field and the mouse is clicked one or more times.

4. The method as defined in claim 1, wherein each said action is selected from the group consisting of.
a request for one or more of a display of a menu and an activation of a menu item of a menu;
a request for one or more of a display of a tool bar and an activation of a command tool of a tool bar;
an editing operation with respect to data in at least one said operable field that is one or more of an undo function, a redo function, a copy function, a cut function, a paste function, an insertion of a hyperlink, and a carriage return or line feed function;
performing a character formatting operation with respect to data in at least one said operable field that is one or more of a boldface, an italics, an underlining, a change of font size or font color, character spacing, and text effects; and
adding, entering, updating or deleting, with respect to at least one said operable field, one or more of a repeating operable field, an optional operable field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

5. The method as defined in claim 1, wherein the availability of each said action is determined on the basis of the context of each said operable field of the electronic form with respect to at least one other said operable field of the electronic form.

6. The method as defined in claim 1, wherein discovering the solution includes discovering a solution identifier in the data file, computing a special name from the solution identifier, and discovering the solution using the special name.

7. The method as defined in claim 1, wherein the data file includes primarily data.

8. The method as defined in claim 1, wherein the data file is written in XML.

9. The method as defined in claim 1, wherein:
the solution includes a presentation application that includes the electronic form; and
the presentation file contains logic to gives the display of the electronic form a graphical, visual representation of the operable fields.

10. The method as defined in claim 9, wherein the presentation application is written in XSLT.

11. The method as defined in claim 1, wherein the solution includes a logic application for ensuring the validity of the received data that is entered into the operable fields of the electronic form.

12. The method as defined in claim 11, wherein the logic application includes an XML schema.

13. The method as defined in claim 1, wherein the electronic form is written in XHTML.

14. A computer-readable medium comprising computer-executable instructions that perform the method as defined in claim 1 when executed by a computer.

15. A method comprising:
displaying an electronic form containing operable fields corresponding to one or more components that correspond to one or more nodes in a tree arrangement of hierarchical data, each said node having a structure, wherein:
the operable fields have a hierarchical arrangement in the display of the electronic form; and
the hierarchical arrangement of the operable fields in the electronic form visually mimics:
the one or more nodes in the tree arrangement of hierarchical data; and
the structure of each said node;
enabling a user to enter data into the operable fields of the electronic form;
receiving data entered into the operable fields of the electronic form, wherein each said node has an attribute associated therewith that defines the availability of one or more actions to the user when the user enters the data into each said operable field of the electronic form; and
altering the hierarchical data in a data file so as to correspondingly reflect the data received.

16. The method as defined in claim 15, wherein the availability of one or more actions to the user concurs with an event elected from the group consisting of:
an association of an input device being used by the user with one said operable field;
a cursor position corresponding to an input device being used by the user is proximal to one said operable field;
one said operable field is selected by the user by use of an input device;
one said operable field on the electronic form is made to be an active field by operation of an input device being used by the user;
specific conditions are met;
specific conditions are met with respect to the data in the one said operable field;
when the user's mouse pointer for an input device rests over, within, or proximal to an editable region of one said operable field; when the user's mouse pointer for an input device rests over, within, or proximal to an editable region of one said operable field and the mouse is clicked one or more times.

17. The method as defined in claim 15, wherein each said action is selected from the group consisting of:
displaying a menu containing one or more menu items with the electronic form;
displaying a toolbar containing one or more command tools with the electronic form;
selecting a menu item from a menu that is displayed with the electronic form;
selecting a command tool from a tool bar that is displayed with the electronic form;
an editing operation with respect to data in at least one said operable field that is one or more of an undo function, a redo function, a copy function, a cut function, a paste function, an insertion of a hyperlink, and a carriage return or line feed function;
performing a character formatting operation with respect to data in at least one said operable field that is one or more of a boldface, an italics, an underlining, a change of font size or font color, character spacing, and text effects; and
adding, entering, updating or deleting, with respect to at least one said operable field, one or more of a repeating operable field, an optional operable field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

18. The method as defined in claim 15, wherein the displaying further comprises creating the electronic form using an XSLT document.

19. The method as defined in claim 18, wherein:
the XSLT document is a compilation of the components; and
the components are XSLT components.

20. The method as defined in claim 15, wherein the tree arrangement of hierarchical data is part of a generalized instance.

21. The method as defined in claim 20, where the generalized instance includes all possible instances for each node of the tree arrangement of hierarchical data.

22. A computer-readable medium comprising computer-executable instructions that perform the method as defined in claim 15, when executed by a computer.

23. A method comprising:
receiving an instruction to open a markup-language document having a solution identifier;
computing a special name using the solution identifier;
discovering a solution using the special name;
opening the markup-language document with the solution, wherein:
the solution includes a presentation application and a markup-language schema;
the markup-language document can be inferred from the markup-language schema; and
portions of the markup-language document are logically coupled with fragments of the markup-language schema;
executing the presentation application to render an electronic form containing data-entry fields associated with the coupled portions;
enabling a user to enter data into the data-entry fields of the electronic form, wherein at least one of the presentation application and the mark-up language schema define the availability of one or more actions that are made available to the user when entering the data into each said data-entry field of the electronic form;
receiving data entered into the data-entry fields of the electronic form; and
altering hierarchical data in the markup-language document so as to correspondingly reflect the data received.

24. The method as defined in claim 23, wherein:
the markup-language document is written in XML;
the presentation application is written in XSLT;
the electronic form is written in XHTML; and
the solution further comprises a manifest of all files that can be used for:
representing the markup-language document in the electronic form;
allowing a user in input data into the one or more data-entry fields; and
validating the data that the user inputs into the one or more data-entry fields.

25. The method as defined in claim 23, wherein the coupled portions contain information setting forth all possible markup-language documents for the coupled portions.

26. The method as defined in 23, wherein the data-entry fields of the electronic form map to a corresponding plurality of nodes of the markup-language document; and
the method further comprises:
receiving, through one or more said data-entry fields, data input by a user for storage in a corresponding said node in the markup-language document; and
outputting data in the markup-language for viewing by the user in the electronic form through the data-entry fields via the mapping of the data-entry fields from corresponding said nodes of the markup-language document.

27. The method as defined in claim 26, wherein:
the markup-language schema includes a logic application; and
the method further comprises:
executing the logic application to perform a validation to determine if the data received by input from the user is valid or invalid; and
when the validation determines that the data received by input from the user is invalid, outputting a dialog box bearing indicia informing the user that the data input is invalid.

28. The method as defined in claim 27, wherein:
the validation is performed on the data received by input from the user into each said data-entry field with a validation rule;
the logic application comprises a plurality of the validation rules for:
a corresponding plurality of the nodes in the markup-language document; and
a corresponding plurality of the data-entry fields; the validation uses each said validation rule to:
determine if the data received by input from the user into a corresponding said data-entry field is valid or invalid; and
require the user to correct any data input into the corresponding said data-entry field that the validation determines to be invalid.

29. The method as defined in claim 28, wherein each said validation rule is at least one of:
based on a part of a schema governing a corresponding said node;
written in script and associated with a corresponding said node; and
written in a declarative syntax and associated with a corresponding said node.

30. The method as defined in claim 28, wherein:
each said validation rule includes an alert area display; and
the validation further comprises using one said validation rule to determine that the data received by input from the user into a corresponding said data-entry field is invalid and outputting the corresponding alert area display so as to be associated with the corresponding said data-entry field.

31. The method as defined in claim 30, wherein when the alert area display is output, the output includes one or more characteristics selected from the group consisting of:
graphics surrounding the corresponding said data-entry field;
the alert area display surrounds the corresponding said data-entry field;
the alert area display includes graphics containing a red, dashed-lined box;
the alert area display includes graphics highlighting the data in the corresponding said data-entry field;
the alert area display surrounds the corresponding said data-entry field and includes the graphics containing a squiggly line beneath the data in the corresponding said data-entry field;
the alert area display includes text containing information about the invalid data in the corresponding said data-entry field;
the alert area display includes text containing information about the corresponding said data-entry field; and
the alert area display includes a pop-up window.

32. The method as defined in claim 28, wherein each said node has one or more of the validation rules associated therewith.

33. The method as defined in claim 28, wherein one said validation rule includes a requirement that the data received by input from the user into a corresponding said data-entry field is to be is at least one of:
within a certain range;
within a certain range of text or numerals for a setting of one or more bounds of the certain range;
numerical;
textual; and
a reference to another said node in the data file.

34. The method as defined in claim 28, wherein the plurality of the validation rules are associated by mapping to the corresponding plurality of the nodes in the data file.

35. The method as defined in claim 28, wherein each said validation rule is at least one of:
associated by mapping to a corresponding said data-entry field by an XPath expression; and
associated by mapping to a corresponding said data-entry field by use of a declarative syntax.

36. The method as defined in claim 28, wherein each said validation rule is script-based.

37. The method as defined in claim 36, wherein the script-based validation rule maps to a corresponding said node with at least one of:
an XPath expression;
an event handler;
an event handler that determines when a real-time validation tool uses the script-based validation rule;
an event handler that determines when a real-time validation tool uses the script-based validation rule before data received for the node is held by the data file; and
an event handler that determines when a real-time validation tool uses the script-based validation rule after data received for the node is held by the data file.

38. The method as defined in claim 28, wherein each said validation rule includes:
an alert area display; and
how the alert area display is to appear when output.

39. A computer-readable medium comprising instruction that, when executed by a computer, performs the method as defined in claim 23.

40. A computer-readable medium comprising computer-executable instructions that perform the following when executed by a computer:
enabling a user to input data into a first node of a hierarchical data file;
changing the hierarchical data file by retaining the data in the first node of the hierarchical data file;
applying a transformation file on the changed hierarchical data file; and
enabling the user to input data into a second node of the hierarchical data file, wherein each of the first and second nodes have an attribute associated therewith that respectively defines the availability of one or more actions to the user when inputting the data into the first and second nodes of the hierarchical data file.

41. The computer-readable medium as defined in claim 40, wherein the availability of one or more actions to the user concurs with an event elected from the group consisting of:
an association of an input device being used by the user with at least one of the first and second nodes of the hierarchical data file;
a cursor position corresponding to an input device being used by the user is proximal to at least one of the first and second nodes of the hierarchical data file;
at least one of the first and second nodes of the hierarchical data file is selected by the user by use of an input device;
at least one of the first and second nodes of the hierarchical data file is made to be an active field by operation of an input device being used by the user;
specific conditions are met;
specific conditions are met with respect to the data in at least one of the first and second nodes of the hierarchical data file;
when the user's mouse pointer for an input device rests over, within, or proximal to an editable region of at least one of the first and second nodes of the hierarchical data file;
when the user's mouse pointer for an input device rests over, within, or proximal to an editable region of at least one of the first and second nodes of the hierarchical data file and the mouse is clicked one or more times.

42. The computer-readable medium as defined in claim 40, wherein each said action is selected from the group consisting of:
displaying a menu containing one or more menu items;
displaying a toolbar containing one or more command tools;
selecting a menu item from a menu that is displayed;
selecting a command tool from a tool bar that is displayed;
an editing operation with respect to data in at least one of the first and second nodes that is one or more of an undo function, a redo function, a copy function, a cut function, a paste function, an insertion of a hyperlink, and a carriage return or line feed function;
performing a character formatting operation with respect to data in at least one of the first and second nodes that is one or more of a boldface, an italics, an underlining, a change of font size or font color, character spacing, and text effects; and
adding, entering, updating or deleting, with respect to at least one of the first and second nodes, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

43. The computer-readable medium as defined in claim 40, wherein the applying is performed on only a portion of the changed hierarchical data file.

44. The computer-readable medium as defined in claim 40, wherein the applying is performed prior to the enabling the user to input data into the second node.

45. The computer-readable medium as defined in claim 40, wherein the hierarchical data file is written in XML and the transformation file is written in XSLT.

46. The computer-readable medium as defined in claim 40, wherein the applying produces a rendering file.

47. The computer-readable medium as defined in claim 46, further comprising computer-executable instructions that, when executed by the computer, render the rendering file to produce a rendered form having first and second data-entry fields respectively corresponding to the first node and the second node.

48. The computer-readable medium as defined in claim 46, further comprising computer-executable instructions that, when executed by the computer, render the partial rendering file to produce a partial rendered form having a first data-entry field corresponding to the first node.

49. The computer-readable medium as defined in claim 46, further comprising computer-executable instructions that, when executed by the computer, render the partial rendering file to produce a partial rendered form that represents the change made to the hierarchical data file.

50. The computer-readable medium claim 40, wherein:
the applying produces a partial rendering file written in XSLT: and
the computer-readable medium further comprises computer-executable instructions that, when executed by the computer, render the partial rendering file to produce a partial rendered form written in XHTML that represents the change made to the hierarchical data file.

51. A computer-readable medium storing computer-executable instructions that, when executed by a computing device, perform acts comprising:
displaying an electronic form containing one or more data-entry fields that correspond to one or more nodes in a tree arrangement of hierarchical data, wherein the data-entry fields can be edited by an end user; and
enabling the user to enter data into the data-entry fields of the electronic form, wherein each said node has an attribute associated therewith that defines the availability of one or more actions to the user when the user enters the data into each said data-entry field of the electronic form.

52. The computer-readable medium as defined in claim 51, further comprising computer-executable instructions that, when executed by the computer:
receiving data entered into the data-entry fields of the electronic form; and
altering the data file to reflect the data received.

53. The computer-readable medium as defined in claim 51, wherein the displaying further comprises creating the electronic form using an XSL-T file.

54. The computer-readable medium as defined in claim 53, wherein the XSLT file includes XSLT components.

55. The computer-readable medium as defined in claim 51, wherein the availability of one or more actions to the user concurs with an event elected from the group consisting of:
an association of an input device being used by the user with one said data-entry field on the electronic form;
a cursor position corresponding to an input device being used by the user is proximal to one said data-entry field on the electronic form;
one said data-entry field on the electronic form is selected by the user by use of an input device;
one said data-entry field on the electronic form is made to be an active field by operation of an input device being used by the user;
specific conditions are met;
specific conditions are met with respect to the data in the one said data-entry field on the electronic form;
when the user's mouse pointer for an input device rests over, within, or proximal to an editable region of one said data-entry field on the electronic form;
when the user's mouse pointer for an input device rests over, within, or proximal to an editable region of one said data-entry field on the electronic form and the mouse is clicked one or more times.

56. The computer-readable medium as defined in claim 51, wherein each said action is selected from the group consisting of:
displaying a menu containing one or more menu items with the electronic form;
displaying a toolbar containing one or more command tools with the electronic form;
selecting a menu item from a menu that is displayed with the electronic form;
selecting a command tool from a tool bar that is displayed with the electronic form;
an editing operation with respect to data in at least one said data-entry field on the electronic form that is one or more of an undo function, a redo function, a copy function, a cut function, a paste function, an insertion of a hyperlink, and a carriage return or line feed function;
performing a character formatting operation with respect to data in at least one said data-entry field on the electronic form that is one or more of a boldface, an italics, an underlining, a change of font size or font color, character spacing, and text effects; and
adding, entering, updating or deleting, with respect to at least one said data-entry field on the electronic form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

57. An apparatus comprising:
means for enabling a user to input data into a first node of a hierarchical data file;
means for storing the data in the first node of the hierarchical data file;
means for changing the hierarchical data file by applying a transformation file on the hierarchical data file containing the data;
means for viewing the change in the hierarchical data file in an electronic form;
means for enabling the user to input data into a second node of the hierarchical data file; and
means, respectively associated with the first and second nodes, for defining the availability of one or more actions to the user when the user inputs the data into the first and second nodes of the hierarchical data file.

58. The apparatus as defined in claim 57, wherein the availability of one or more actions to the user concurs with an event elected from the group consisting of:
an association of an input device being used by the user with at least one of the first and second nodes;
a cursor position of an input device being used by the user is correspondingly proximal to at least one of the first and second nodes;
at least one of the first and second nodes is correspondingly selected by the user by use of an input device;
at least one of the first and second nodes is made to be an active field by a cursor position corresponding to an input device being used by the user;
specific conditions are met;
specific conditions are met with respect to the data in at least one of the first and second nodes;
when the user's mouse pointer for an input device rests over, within, or proximal to an editable region that corresponds to at least one of the first and second nodes;
when the user's mouse pointer for an input device rests over, within, or proximal to an editable region that corresponds to at least one of the first and second nodes and the mouse is clicked one or more times.

59. The apparatus as defined in claim 57, wherein each said action is selected from the group consisting of:
displaying a menu containing one or more menu items;
displaying a toolbar containing one or more command tools;
selecting a menu item from a menu that is displayed;
selecting a command tool from a tool bar that is displayed;
an editing operation with respect to data in at least one of the first and second nodes, wherein the editing operation is one or more of an undo function, a redo function, a copy function, a cut function, a paste function, an insertion of a hyperlink, and a carriage return or line feed function;
performing a character formatting operation with respect to data in at least one of the first and second nodes, wherein the character formatting operation is one or more of a boldface, an italics, an underlining, a change of font size or font color, character spacing, and text effects; and
adding, entering, updating or deleting, with respect to at least one of the first and second nodes, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

60. An apparatus comprising:
means for displaying an electronic form with data-entry fields associated with nodes of a hierarchical data file;
means for enabling a user to input data into a first data-entry field of the data-entry fields;
means for receiving data input into the first data-entry field;
means for validating the data in the first data-entry field to determine if the data is valid or invalid;
means for enabling the user to input data into a second data-entry field of the data-entry fields if the data in the first data-entry field is valid, or else alerting the user if the data in the first data-entry field is invalid; and
means, respectively associated with the first and second nodes, for defining:
the availability of one or more actions to the user when the user inputs the data into the first and second data-entry fields of the data-entry fields; and
the validity of the data input into the first and second data-entry fields of the data-entry fields.

61. The apparatus as defined in claim 60, wherein the availability of one or more actions to the user concurs with an event elected from the group consisting of:
an association of said data-entry field with means, used by the user, for making input;
a cursor position corresponding to the means for making input that is proximal to at least one said data-entry field;
at least one said data-entry field is selected by the user by use of the means for making input;
at least one said data-entry field is made to be an active field by operation of the means for making input being used by the user;
specific conditions are met;
specific conditions are met with respect to the data in at least one said data-entry field;
when the user's mouse pointer for the means for making input rests over, within, or proximal to an editable region of at least one said data-entry field;
when the user's mouse pointer for the means for making input rests over, within, or proximal to an editable region of at least one said data-entry field and the mouse is clicked one or more times.

62. The apparatus as defined in claim 60, wherein each said action is selected from the group consisting of:
displaying a menu containing one or more menu items with the electronic form;
displaying a toolbar containing one or more command tools with the electronic form;
selecting a menu item from a menu that is displayed with the electronic form;
selecting a command tool from a tool bar that is displayed with the electronic form;
an editing operation with respect to data in at least one said data-entry field that is one or more of an undo function, a redo function, a copy function, a cut function, a paste function, an insertion of a hyperlink, and a carriage return or line feed function;
performing a character formatting operation with respect to data in at least one said data-entry field that is one or more of a boldface, an italics, an underlining, a change of font size or font color, character spacing, and text effects; and
adding, entering, updating or deleting, with respect to at least one said data-entry field, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

63. An apparatus comprising:
means for displaying a representation of a data file;
means for selecting the data file;
means for discovering and deploying, without user interaction, a solution application governing the data file;
means for displaying an electronic form representing a product of the solution application and the data file;
means for enabling a user to enter data into the electronic form;
means, within or referred to by the solution, for defining the availability of one or more actions to the user when entering the data into the electronic form;
means for receiving data entered into the electronic form; and
means for altering the data file to reflect the data received.

64. The apparatus as defined in claim 63, wherein the availability of one or more actions to the user concurs with an event elected from the group consisting of:
an association a data-entry field on the electronic form with means, used by the user, for making input;
a cursor position corresponding to a data-entry field on the electronic form with means, used by the user, for making input;
a data-entry field on the electronic form is selected by the user by use of the means for making input;
at least one data-entry field on the electronic form is made to be an active field by operation of the means for making input being used by the user;
specific conditions are met;
specific conditions are met with respect to data in at least one data-entry field on the electronic form;
when the user's mouse pointer for the means for making input rests over, within, or proximal to an editable region of at least one data-entry field on the electronic form;
when the user's mouse pointer for the means for making input device rests over, within, or proximal to an editable region of at least one data-entry field on the electronic form and the mouse is clicked one or more times.

65. The apparatus as defined in claim 63, wherein each said action is selected from the group consisting of:
displaying a menu containing one or more menu items with the electronic form;
displaying a toolbar containing one or more command tools with the electronic form;
selecting a menu item from a menu that is displayed with the electronic form;
selecting a command tool from a tool bar that is displayed with the electronic form;
an editing operation with respect to data in a data-entry field in the electronic form that is one or more of an undo function, a redo function, a copy function, a cut function, a paste function, an insertion of a hyperlink, and a carriage return or line feed function;
performing a character formatting operation with respect to data in a data-entry field in the electronic form that is one or more of a boldface, an italics, an underlining, a change of font size or font color, character spacing, and text effects; and
adding, entering, updating or deleting, with respect to a data-entry field in the electronic form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

66. A system comprising:
a computer having a display;
a user interface executable on the computer and configured to:
display in the display a rendered form containing a data-entry field mapped to a node of a hierarchical data file; and
receive data input into the data-entry field, wherein the node of the hierarchical data file has an attribute associated therewith that defines the availability of one or more actions to a user when inputting the data into the data-entry field;
a user-input device facilitating the user's input of data into the data-entry field, and
an electronic forms application executable on the computer and configured to update the rendered form to reflect a change in the hierarchical data file through data received in the data-entry field.

67. The system as defined in claim 66, wherein the availability of one or more actions to the user concurs with an event elected from the group consisting of:
an association of the data-entry field on the rendered form with an input device;
a cursor position corresponding to the data-entry field on the rendered form with the input device;
the data-entry field on the rendered form is selected by the user by use of the input device;
the data-entry field on the rendered form is made to be an active field by operation of the input device;
specific conditions are met;
specific conditions are met with respect to data in the data-entry field on the rendered form;
when the user's mouse pointer for the input device rests over, within, or proximal to an editable region of the data-entry field on the rendered form;
when the user's mouse pointer for the input device rests over, within, or proximal to an editable region of the data-entry field on the rendered form and the mouse is clicked one or more times.

68. The system as defined in claim 66, wherein each said action is selected from the group consisting of:
displaying a menu containing one or more menu items with the rendered form;
displaying a toolbar containing one or more command tools with the rendered form;
selecting a menu item from a menu that is displayed with the rendered form;
selecting a command tool from a tool bar that is displayed with the rendered form;
an editing operation with respect to data in the data-entry field on the rendered form that is one or more of an undo function, a redo function, a copy function, a cut function, a paste function, an insertion of a hyperlink, and a carriage return or line feed function;
performing a character formatting operation with respect to data in the data-entry field on the rendered form that is one or more of a boldface, an italics, an underlining, a change of font size or font color, character spacing, and text effects; and
adding, entering, updating or deleting, with respect to the data-entry field in the rendered form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

69. A system comprising:
a computer having a display;
a user interface executable on the computer and configured to:
display in the display an electronic form containing a data-entry field mapped to a node of a hierarchical data file; and
receive data input into the data-entry field;
a user-input device facilitating a user's input of data into the data-entry field, and
an electronic forms application executable on the computer and configured to perform operations, in real-time, with respect to the data-entry field, wherein:
the node of the hierarchical data file has an attribute associated therewith that defines the availability to the user of one or more actions when the user enters the data into the data-entry field; and
the operations include making the one of more actions available to the user when the user enters the data into the data-entry field.

70. The system as defined in claim 69, wherein the availability of one or more actions to the user concurs with an event elected from the group consisting of:
an association of the data-entry field on the electronic form with an input device;
a cursor position corresponding to the data-entry field on the electronic form with the input device;
the data-entry field on the electronic form is selected by the user by use of the input device;
the data-entry field on the electronic form is made to be an active field by operation of the input device;
specific conditions are met;
specific conditions are met with respect to data in the data-entry field on the electronic form;
when the user's mouse pointer for the input device rests over, within, or proximal to an editable region of the data-entry field on the electronic form;
when the user's mouse pointer for the input device rests over, within, or proximal to an editable region of the data-entry field on the electronic form and the mouse is clicked one or more times.

71. The system as defined in claim 69, wherein each said action is selected from the group consisting of:
displaying a menu containing one or more menu items with the electronic form;
displaying a toolbar containing one or more command tools with the electronic form;
selecting a menu item from a menu that is displayed with the electronic form;
selecting a command tool from a tool bar that is displayed with the electronic form;
an editing operation with respect to data in the data-entry field on the electronic form that is one or more of an undo function, a redo function, a copy function, a cut function, a paste function, an insertion of a hyperlink, and a carriage return or line feed function;
performing a character formatting operation with respect to data in the data-entry field on the electronic form that is one or more of a boldface, an italics, an underlining, a change of font size or font color, character spacing, and text effects; and
adding, entering, updating or deleting, with respect to the data-entry field in the electronic form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

72. The system as defined in claim 69, wherein:
the attribute further defines one or more validation rules; and
the operations further comprise validating the data input into the data-entry field against the one or more validation rules.

73. A user interface comprising:
a rendered form containing a data-entry field mapped to a node of a hierarchical data file;
an interface to enable a user to input data into the data-entry field, wherein the node of the hierarchical data file has an attribute associated therewith that defines the availability of one or more actions to the user when inputting the data into the data-entry field; and
a hierarchical data processing engine to update portions of the rendered form that are out-of-date because of a change to the hierarchical data file caused by the data input into the data-entry field.

74. The user interface as defined in claim 73, wherein the availability of one or more actions to the user concurs with an event elected from the group consisting of:
an association of the data-entry field on the rendered form with an input device;
a cursor position corresponding to the data-entry field on the rendered form with the input device;
the data-entry field on the rendered form is selected by the user by use of the input device;
the data-entry field on the rendered form is made to be an active field by operation of the input device;
specific conditions are met;
specific conditions are met with respect to data in the data-entry field on the rendered form;
when the user's mouse pointer for the input device rests over, within, or proximal to an editable region of the data-entry field on the rendered form;
when the user's mouse pointer for the input device rests over, within, or proximal to an editable region of the data-entry field on the rendered form and the mouse is clicked one or more times.

75. The user interface as defined in claim 73, wherein each said action is selected from the group consisting of:
displaying a menu containing one or more menu items with the rendered form;
displaying a toolbar containing one or more command tools with the rendered form;
selecting a menu item from a menu that is displayed with the rendered form;
selecting a command tool from a tool bar that is displayed with the rendered form;
an editing operation with respect to data in the data-entry field on the rendered form that is one or more of an undo function, a redo function, a copy function, a cut function, a paste function, an insertion of a hyperlink, and a carriage return or line feed function;
performing a character formatting operation with respect to data in the data-entry field on the rendered form that is one or more of a boldface, an italics, an underlining, a change of font size or font color, character spacing, and text effects; and
adding, entering, updating or deleting, with respect to the data-entry field in the rendered form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

76. A user interface comprising:
a rendered form containing a plurality of data-entry fields respectively mapped to a plurality of nodes of a hierarchical XML data file having a schema that includes validation rules corresponding the plurality of nodes, wherein each said data-entry field on the rendered form contains a display of an HTML representation of corresponding XML data in the hierarchical XML data file; and
an interface to enable a user to edit the XML data in the hierarchical XML data file using the corresponding data-entry fields of the rendered form, wherein:
the user can edit the XML data without the XML tags of the hierarchical XML data file being displayed on the rendered form; and
the editing of the XML data by the user is subject to the validation rules in the schema that correspond to the nodes of the hierarchical XML data file.

77. The user interface as defined in claim 76, wherein:
each said node has a corresponding attribute in the schema that defines an availability of one or more actions to the user when editing the XML data using the corresponding data-entry fields; and
the availability of the one or more actions to the user concurs with an association of an input device being used by the user with each said data-entry field.

78. The user interface as defined in claim 77, wherein the availability of one or more actions to the user concurs with an event elected from the group consisting of:
an association of the data-entry field on the rendered form with an input device;
a cursor position corresponding to the data-entry field on the rendered form with the input device;
the data-entry field on the rendered form is selected by the user by use of the input device;
the data-entry field on the rendered form is made to be an active field by operation of the input device;
specific conditions are met;
specific conditions are met with respect to data in the data-entry field on the rendered form;
when the user's mouse pointer for the input device rests over, within, or proximal to an editable region of the data-entry field on the rendered form;
when the user's mouse pointer for the input device rests over, within, or proximal to an editable region of the data-entry field on the rendered form and the mouse is clicked one or more times.

79. The user interface as defined in claim 77, wherein each said action is selected from the group consisting of:
displaying a menu containing one or more menu items with the rendered form;
displaying a toolbar containing one or more command tools with the rendered form;
selecting a menu item from a menu that is displayed with the rendered form;
selecting a command tool from a tool bar that is displayed with the rendered form;
an editing operation with respect to data in the data-entry field on the rendered form that is one or more of an undo function, a redo function, a copy function, a cut function, a paste function, an insertion of a hyperlink, and a carriage return or line feed function;
performing a character formatting operation with respect to data in the data-entry field on the rendered form that is one or more of a boldface, an italics, an underlining, a change of font size or font color, character spacing, and text effects; and
adding, entering, updating or deleting, with respect to the data-entry field in the rendered form, one or more of a repeating data-entry field, an optional data-entry field, a spreadsheet, a table, a row or a column in a table, a text box, multiple spaces, a header, a footer, an image, a graphic, a picture, a link to an image, a link to a graphic, a link to a picture, single line plain text, multi-line plain text, single line formatted text, multi-line formatted text, rich text, a whole number, a decimal, a true/false distinction, a date, and a time.

80. The user interface as defined in claim 76, wherein, when the user edits the hierarchical XML data file to change the hierarchical XML data file from an initial version to a final version:
the editing is subject to the validation rules in the schema;
the initial version is different from the final version; and
the initial version and the final version both adhere to the schema due to the use of the validation rules in the schema during the editing.

81. The user interface as defined in claim 76, further comprising a data processing engine to update portions of the rendered form that are out-of-date because of a change to the hierarchical data file caused by the user editing the XML data in the hierarchical XML data file using the corresponding data-entry fields of the rendered form.

82. The user interface as defined in claim 77, wherein each said action is selected from the group consisting of:
adding, entering, updating or deleting, with respect to the data-entry field in the rendered form, one or more of:
a field in a block;
a list; and
an item in a list;
inserting or removing, with respect to the data-entry field in the rendered form, an optional block; and
replacing, with respect to the data-entry field in the rendered form, an inserted block with another block.

83. The user interface as defined in claim 82, wherein the list is selected from the group consisting of:
one or more tables;
one or more rows or columns in a table;
one or more text lists;
a one or more text items in a text list; and
one or more repeating blocks.
